(19) United States
(12) Patent Application Publication
(10) Pub. No.: US 2004/0224251 A1
(43) Pub. Date: Nov. 11, 2004

(54) Positive resist composition

(76) Inventors: Kouji Toishi, Osaka (JP); Yasunori Uetani, Tsukuba-shi (JP)

Correspondence Address: BIRCH STEWART KOLASCH & BIRCH, PO BOX 747, FALLS CHURCH, VA, 22040-0747, US

(21) Appl. No.: 10/667,456

(22) Filed: Sep. 23, 2003

(30) Foreign Application Priority Data
Sep. 25, 2002 (JP) 2002-278714

(51) Int. Cl. G03C 1/492

(52) U.S. Cl. 430/270.1; 430/280.1; 430/907

(57) ABSTRACT

The present invention provides a positive resist composition comprising

(A) a resin which itself is insoluble or poorly soluble in an alkali aqueous solution but becomes soluble in an alkali aqueous solution by the action of an acid, wherein the content of halogen atoms in the resin is 40% by weight or more, at least one of structural units constituting the resin is a structural unit having an alicyclic hydrocarbon skeleton, and the structural unit having an alicyclic hydrocarbon skeleton contains therein at least one group rendering the resin soluble in an alkali aqueous solution by the action of an acid, and at least one halogen atom, and a carbon in the alicyclic hydrocarbon skeleton may be substituted by an oxygen, and

(B) (a) an acid generator comprising a sulfonium salt of the formula (I)

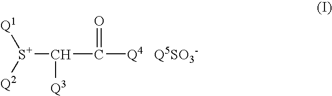

wherein Q¹, Q², Q³ and Q⁴ are defined in the specification, and

(b) a triphenylsulfonium salt of the formula (IIa) and/or a diphenyliodonium salt of the formula (IIb)

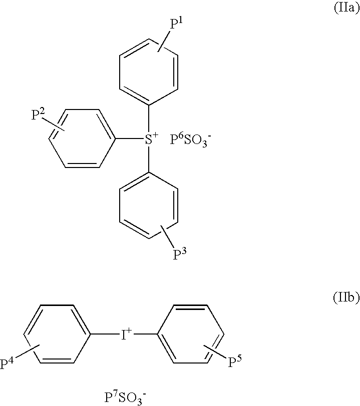

wherein P¹, P², P³, P⁴, P⁵, P⁶SO₃⁻ and P⁷SO₃⁻ are defined in the specification.

### BACKGROUND OF THE INVENTION

1. Field of the Invention

The present invention relates to a positive resist composition used in fine processing of semiconductors.

2. Related Art

Semiconductor microfabrication employs a lithography process using a resist composition. In lithography, theoretically, the shorter the exposure wavelength becomes, the higher the resolution can be made, as expressed by Rayleigh's diffraction limit formula. The wavelength of an exposure light source for lithography used in the manufacture of semiconductor devices has been shortened year by year as g line having a wavelength of 436 nm, i line having a wavelength of 365 nm, KrF excimer laser having a wavelength of 248 nm and ArF excimer laser having a wavelength of 193 nm. F₂ excimer laser having a wavelength of 157 nm seems to be promising as the next-generation exposure light source. For exposure to KrF excimer laser and ArF excimer laser, what is called chemical amplification type resists utilizing the catalytic action of an acid generated by exposure are often used due to excellent sensitivity. Further, also for exposure to F2 excimer laser, there is a high possibility of use of chemical amplification type resists due to excellent sensitivity.

As disclosed in JP2002-116546, a resist giving improved line edge roughness for exposure to ArF excimer laser by using sulfonium salts is proposed.

However, resins used in resists for KrF excimer laser exposure and ArF excimer laser exposure do not show sufficient transmittance for lights of wavelengths of 170 nm or less, for example, F2 excimer laser having a wavelength of 157 nm. When transmittance is lower, various properties such as profile, contrast, sensitivity and the like are badly influenced.

### SUMMARY OF THE INVENTION

An object of the present invention is to provide a resist composition excellent in transmittance to lights of wavelengths of 170 nm or less, especially suitable for F2 excimer laser lithography.

The present invention relates to the followings:

<1> A positive resist composition comprising

(A) a resin which itself is insoluble or poorly soluble in an alkali aqueous solution but becomes soluble in an alkali aqueous solution by the action of an acid, wherein the content of halogen atoms in the resin is 40% by weight or more, at least one of structural units constituting the resin is a structural unit having an alicyclic hydrocarbon skeleton, and the structural unit having an alicyclic hydrocarbon skeleton contains therein at least one group rendering the resin soluble in an alkali aqueous solution by the action of an acid, and at least one halogen atom, and a carbon in the alicyclic hydrocarbon skeleton may be substituted by an oxygen, and

(B) (a) an acid generator comprising a sulfonium salt of the formula (I)

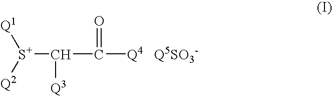

wherein Q¹ and Q² each independently represent alkyl having 1 to 6 carbon atoms or cycloalkyl having 3 to 10 carbon atoms, or Q¹ and Q² bond to form divalent acyclic hydrocarbon having 3 to 7 carbon atoms which form a ring together with the adjacent S⁺, and at least one —CH₂— in the divalent acyclic hydrocarbon may be substituted by —CO—, —O— or —S—; Q³ represent hydrogen, Q⁴ represents alkyl having 1 to 6 carbon atoms, cycloalkyl having 3 to 10 carbon atoms or phenyl optionally substituted by alkyl having 1 to 6 carbon atoms, or Q³ and Q⁴ bond to form 2-oxocycloalkyl together with the adjacent —CHCO—, and Q⁵SO₃⁻ represents organic sulfonate ion, and

(b) at least one onium salt selected from the group consisting of a triphenylsulfonium salt of the formula (IIa) and a diphenyliodonium salt of the formula (IIb)

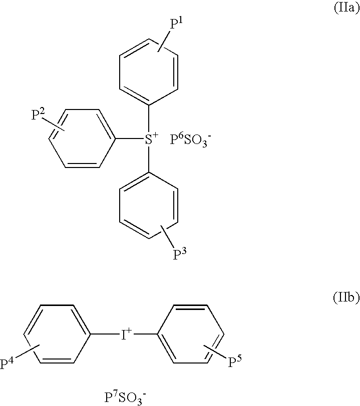

wherein P¹, P², P³, P⁴ and P⁵ each independently represent hydrogen, hydroxyl, alkyl having 1 to 6 carbon atoms or alkoxy having 1 to 6 carbon atoms, and P⁶SO₃⁻ and P⁷SO₃⁻ each independently represent organic sulfonate ion.

<2> The positive resist composition according to <1> wherein Q¹ and Q² bond to form divalent acyclic hydrocarbon having 3 to 7 carbon atoms which form a ring together with the adjacent S⁺, and at least one —CH₂— in the divalent acyclic hydrocarbon may be substituted by —CO—, —O— or —S—.

<3> The positive resist composition according to <1> or <2> wherein Q⁵, P⁶ and P⁷ each independently represent alkyl having 1 to 8 carbon atoms, perfluoroalkyl having 1 to 8 carbon atoms, aromatic group having 6 to 12 carbon atoms or camphor group.

<4> The positive resist composition according to any of <1> to <3> wherein the weight ratio of (b)/(a) is 9 to 1/9 wherein (a) is a sulfonium salt of the formula (I), and (b) is at least one onium salt selected by from the group consisting of a triphenylsulfonium salt of the formula (IIa) and diphenyliodonium salt of the formula (IIb).

<5> The positive resist composition according to any of <1> to <4> wherein the content of the structural unit having an alicyclic hydrocarbon skeleton which contains therein at least one group rendering the resin soluble in an alkali aqueous solution by the action of an acid, and at least one halogen atom, is 15 to 50 mol % in the total structural units in the resin.

<6> The positive resist composition according to any of <1> to <5> wherein the alicyclic hydrocarbon skeleton is a skeleton of the following formula (1):

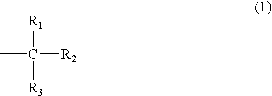

wherein R₂ and R₃ bond to form an alicyclic hydrocarbon ring together with adjacent carbon atom, the alicyclic hydrocarbon ring formed by R₂, R₃ and the carbon atom bonds to at least one group containing a group rendering a resin soluble in an alkali aqueous solution by the action of an acid, and bonds to at least one halogen atom; R₁ represents a hydrogen atom, halogen atom or aliphatic hydrocarbon group.

<7> The positive resist composition according to <6> wherein the cyclic hydrocarbon skeleton of the formula (1) is an alicyclic hydrocarbon skeleton of the formula (2):

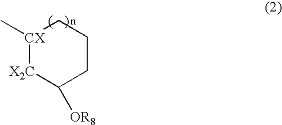

wherein X represents a halogen atom, R₈ represents a hydrogen or an acid-unstable group dissociating in the presence of an acid, and n represents 0 or 1.

<8> The positive resist composition according to <7> wherein the alicyclic hydrocarbon skeleton of the formula (2) is an alicyclic hydrocarbon skeleton containing a partial structure of the formula (3):

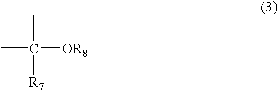

wherein C is a carbon atom forming an alicyclic hydrocarbon skeleton; R₇ represents an alkyl group having 1 to 6 carbon atoms substituted with at least one halogen atom or alicyclic hydrocarbon group substituted with at least one halogen atom; and R₈ has the same meaning as described above.

<9> The positive resist composition according to <8> wherein the cyclic hydrocarbon skeleton of the formula (2) is an alicyclic hydrocarbon skeleton of the formula (4):

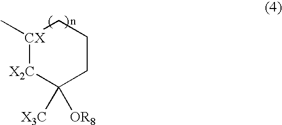

wherein X, R₈ and n have the same meanings as described above.

<10> The positive resist composition according to <9> wherein R₈ is a group of the formula (5):

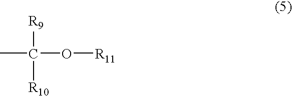

wherein R₉ and R₁₀ each independently represent an alkyl group having 1 to 14 carbon atoms or a hydrogen atom, the alkyl group may have at least one group selected from the group consisting of halogen atoms and alicyclic hydrocarbon groups; R₁₁ represents an alkyl group having 1 to 14 carbon atoms, alicyclic hydrocarbon group, lactone ring group or aromatic hydrocarbon group, the alkyl group may have at least one substituent selected from the group consisting of halogen atom, alicyclic hydrocarbon group and aromatic hydrocarbon group, the alicyclic hydrocarbon group, lactone ring group and aromatic hydrocarbon group in R₁₁ may each independently have at least one substituent selected from the group consisting of halogen atoms and alkyl groups.

<11> The positive resist composition according to <10> wherein in the formula (5), R₉ and R₁₀ represent a hydrogen atom, and R₁₁ represents an ethyl group.

<12> The positive resist composition according to <6> wherein the cyclic hydrocarbon skeleton of the formula (1) is a skeleton of the formula (6):

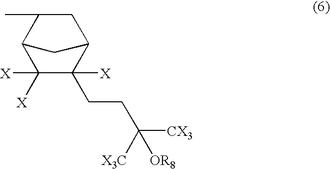

wherein X and R₈ have the same meanings as described above.

<13> The positive resist composition according to any of <1> to <12> wherein the halogen atom is a fluorine atom.

<14> The positive resist composition according to any of <1> to <5> wherein the structural unit having an alicyclic hydrocarbon skeleton is a structural unit of the formula (7):

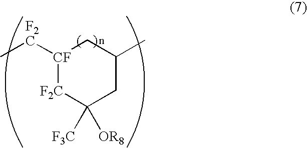

wherein n and R₈ have the same meanings as described above.

<15> The positive resist composition according to any of <1> to <5> wherein the structural unit having an alicyclic hydrocarbon skeleton is a structural unit of the formula (10):

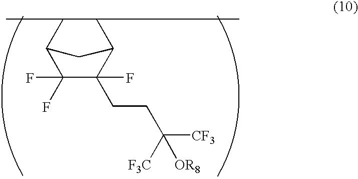

wherein R₈ has the same meaning as described above.

<16> The positive resist composition according to any of <1> to <5> wherein the resin is a copolymer containing a structural unit of the following formula (8) and a structural unit of the following formula (8-1):

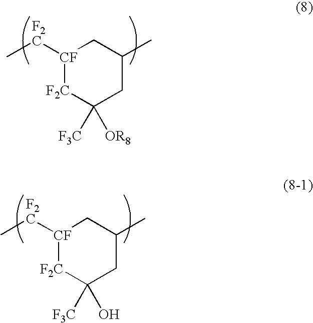

wherein R₈ has the same meaning as described above.

<17> The positive resist composition according to any of <l> to <5> wherein the resin is a copolymer containing a structural unit of the following formula (9) and a structural unit of the following formula (9-1):

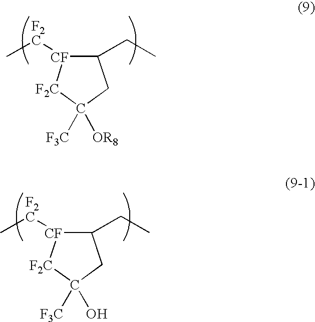

wherein, R₈ has the same meaning as described above.

<18> The positive resist composition according to any of <1> to <5> wherein the resin is a copolymer containing a structural unit of the following formula (10) and a structural unit of the following formula (10-1):

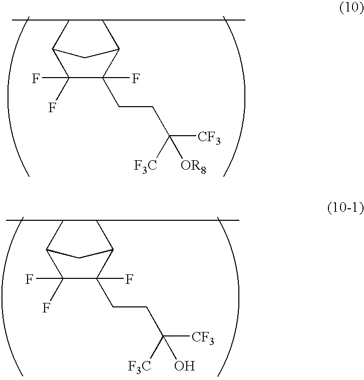

wherein, R₈ has the same meaning as described above.

<19> The positive resist composition according to any of <1> to <5> wherein the resin is a copolymer containing a structural unit of the following formula (11), a structural unit of the following formula (12) and a structural unit of the following formula (12-1):

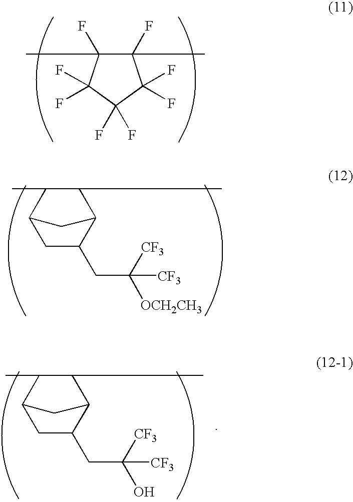

<20> The positive resist composition according to any of <1> to <19> which further comprises a basic nitrogen-containing organic compound as a quencher.

### DESCRIPTION OF PREFERRED EMBODIMENTS

Acid generator used in chemical amplification type resist compositions decomposes to generate an acid by allowing radiation such as light, electron beam and the like to act on the acid generator itself or a resist composition containing the acid generator.

In the present composition, (a) a sulfonium salt of the formula (1) (hereinafter referred to as (a) salt) and (b) at least one onium salt selected from the group consisting of a triphenylsulfonium salt of the formula (IIa) and a diphenyliodonium salt of the formula (IIb) (hereinafter referred to as (b) salt) are used together as the acid generator.

In the formula (I), Q¹ and Q² each independently represent alkyl having 1 to 6 carbon atoms which may be linear or branched in the case of 3 or more carbon atoms; or cycloalkyl having 3 to 10 carbon atoms which may be substituted by alkyl having 1 to 6 carbon atoms; or Q¹ and Q² bond to form divalent acyclic hydrocarbon having 3 to 7 carbon atoms which form a ring together with the adjacent S⁺. At least one —CH₂— in the divalent acyclic hydrocarbon may be substituted by —CO—, —O— or —S—.

Q³ represents hydrogen and Q⁴ represents alkyl having 1 to 6 carbon atoms which may be linear or branched in the case of 3 or more carbon atoms; cycloalkyl having 3 to 10 carbon atoms which may be substituted by alkyl having 1 to 6 carbon atoms; or phenyl optionally substituted by alkyl having 1 to 6 carbon atoms; or Q³ and Q⁴ bond to form 2-oxocycloalkyl together with the adjacent —CHCO—.

In Q¹, Q² and Q⁴, specific examples of the alkyl include methyl, ethyl, propyl, isopropyl, butyl, tert-butyl, pentyl, hexyl and the like, and specific examples of the cycloalkyl include cyclopropyl, cyclobutyl, cyclopentyl, cyclohexyl, cycloheptyl and the like. Specific examples of the ring group formed by adjacent S⁺ and divalent acyclic hydrocarbon by Q¹ and Q² include ethylenesulfonio group, trimethylenesulfonio group, tetramethylenesulfonio goup, pentamethylenesulfonio group, oxybisethylenesulfonio group, carbonybisethylenesulfonio group, thiobisethylenesulfonio group, carbonylbisethylenesulfonio group, thiobisethylenesulfonio group, and the like. Among them, the ring groups formed by adjacent S⁺ and divalent acyclic hydrocarbon by Q¹ and Q² wherein at least one —CH₂— in the divalent acyclic hydrocarbon is substituted by —CO—, —O— or —S— are preferred from the view point of thermal stability.

In Q⁴, specific examples of the phenyl optionally substituted by linear or branched alkyl having 1 to 6 carbon atoms include phenyl, tolyl, xylyl, and the like. Specific examples of the 2-oxocycloalkyl formed by bonding Q³ and Q⁴ together with the adjacent —CHCO— include 2-oxocyclohexyl, 2-oxocyclopentyl, camphor group and the like.

Q⁵SO₃⁻ in the formula (I) represents organic sulfonate ion. Q⁵ may be an organic group having 1 to about 12 carbon atoms. Examples thereof include alkyl having 1 to 8 carbon atoms such as methyl, ethyl, propyl, isopropyl, butyl, pentyl, hexyl, heptyl, and the like; perfluoroalkyl having 1 to 8 carbon atoms such as trifluoromethyl, perfluorobuthyl, perfluorooctyl, and the like; cycloalkyl such as cyclopentyl, cyclohexyl, and the like; aromatic group having 6 to 12 carbon atoms such as phenyl, tolyl, xylyl, mesityl, naphtyl, and the like; camphor group, and the like.

Specific examples of (a) salt include the followings:

dimethyl(2-oxopropyl)sulfonium trifluoromethanesulfonate,

dimethyl(2-oxobutyl)sulfonium trifluoromethanesulfonate,

dimethyl(2-oxopentyl)sulfonium trifluoromethanesulfonate,

dimethyl(2-oxohexyl)sulfonium trifluoromethanesulfonate,

dimethyl(2-oxoheptyl)sulfonium trifluoromethanesulfonate,

dimethyl(2-oxooctyl)sulfonium trifluoromethanesulfonate,

dimethyl(3-methyl-2-oxobutyl)sulfonium trifluoromethanesulfonate,

(3,3-dimethyl-2-oxobutyl)dimethylsulfonium trifluoromethanesulfonate,

(2-cyclohexyl-2-oxoethyl)dimethylsulfonium trifluoromethanesulfonate,

(2-cyclopentyl-2-oxoethyl)dimethylsulfonium trifluoromethanesulfonate,

diethyl(2-oxopropyl)sulfonium trifluoromethanesulfonate,

diethyl(2-oxobutyl)sulfonium trifluoromethanesulfonate,

diethyl(2-oxopentyl)sulfonium trifluoromethanesulfonate,

diethyl(2-oxohexyl)sulfonium trifluoromethanesulfonate,

diethyl(2-oxoheptyl)sulfonium trifluoromethanesulfonate,

diethyl(2-oxooctyl)sulfonium trifluoromethanesulfonate,

diethyl(3-methyl-2-oxobutyl)sulfonium trifluoromethanesulfonate,

(3,3-dimethyl-2-oxobutyl)diethylsulfonium trifluoromethanesulfonate,

(2-cyclohexyl-2-oxoethyl)diethylsulfonium trifluoromethanesulfonate,

(2-cyclopentyl-2-oxoethyl)diethylsulfonium trifluoromethanesulfonate,

dibutyl(2-oxopropyl)sulfonium trifluoromethanesulfonate,

dibutyl(2-oxobutyl)sulfonium trifluoromethanesulfonate,

dibutyl(2-oxopentyl)sulfonium trifluoromethanesulfonate,

dibutyl(2-oxohexyl)sulfonium trifluoromethanesulfonate,

dibutyl(2-oxoheptyl)sulfonium trifluoromethanesulfonate,

dibutyl(2-oxooctyl)sulfonium trifluoromethanesulfonate,

dibutyl(3-methyl-2-oxobutyl)sulfonium trifluoromethanesulfonate,

dibutyl(3,3-dimethyl-2-oxobutyl)sulfonium trifluoromethanesulfonate,

dibutyl(2-cyclohexyl-2-oxoethyl)sulfonium trifluoromethanesulfonate,

dibutyl(2-cyclopentyl-2-oxoethyl)sulfonium trifluoromethanesulfonate,

diisopropyl(2-oxopropyl)sulfonium trifluoromethanesulfonate,

diisopropyl(2-oxobutyl)sulfonium trifluoromethanesulfonate,

diisopropyl(2-oxopentyl)sulfonium trifluoromethanesulfonate,

diisopropyl(2-oxohexyl)sulfonium trifluoromethanesulfonate,

diisopropyl(2-oxoheptyl)sulfonium trifluoromethanesulfonate,

diisopropyl(2-oxooctyl)sulfonium trifluoromethanesulfonate,

diisopropyl(3-methyl-2-oxobutyl)sulfonium trifluoromethanesulfonate,

(3,3-dimethyl-2-oxobutyl)diisopropylsulfonium trifluoromethanesulfonate,

(2-cyclohexyl-2-oxoethyl)diisopropylsulfonium trifluoromethanesulfonate,

(2-cyclopentyl-2-oxoethyl)diisopropylsulfonium trifluoromethanesulfonate,

tert-butylmethyl(2-oxopropyl)sulfonium trifluoromethanesulfonate,

tert-butylmethyl(2-oxobutyl)sulfonium trifluoromethanesulfonate,

tert-butylmethyl(2-oxopentyl)sulfonium trifluoromethanesulfonate,

tert-butylmethyl(2-oxohexyl)sulfonium trifluoromethanesulfonate,

tert-butylmethyl(2-oxoheptyl)sulfonium trifluoromethanesulfonate,

tert-butylmethyl(2-oxooctyl)sulfonium trifluoromethanesulfonate,

tert-butylmethyl(3-methyl-2-oxobutyl)sulfonium trifluoromethanesulfonate,

tert-butyl(3,3-dimethyl-2-oxobutyl)methylsulfonium

trifluoromethanesulfonate,

tert-butyl(2-cyclohexyl-2-oxoethyl)methylsulfonium

trifluoromethanesulfonate,

tert-butyl(2-cyclopentyl-2-oxoethyl)methylsulfonium

trifluoromethanesulfonate,

cyclohexylmethyl(2-oxopropyl)sulfonium trifluoromethanesulfonate,

cyclohexylmethyl(2-oxobutyl)sulfonium trifluoromethanesulfonate,

cyclohexylmethyl(2-oxopentyl)sulfonium trifluoromethanesulfonate,

cyclohexylmethyl(2-oxohexyl)sulfonium trifluoromethanesulfonate,

cyclohexylmethyl(2-oxoheptyl)sulfonium trifluoromethanesulfonate,

cyclohexylmethyl(2-oxooctyl)sulfonium trifluoromethanesulfonate,

cyclohexylmethyl(3-methyl-2-oxobutyl)sulfonium trifluoromethanesulfonate,

cyclohexyl(3,3-dimethyl-2-oxobutyl)methylsulfonium

trifluoromethanesulfonate,

cyclohexyl(2-cyclohexyl-2-oxoethyl)methylsulfonium

trifluoromethanesulfonate,

cyclohexyl(2-cyclopentyl-2-oxoethyl)methylsulfonium

trifluoromethanesulfonate,

1-(2-oxopropyl)thiacyclopentanium trifluoromethanesulfonate,

1-(2-oxobutyl)thiacyclopentanium trifluoromethanesulfonate,

1-(2-oxopentyl)thiacyclopentanium trifluoromethanesulfonate,

1-(2-oxohexyl)thiacyclopentanium trifluoromethanesulfonate,

1-(2-oxoheptyl)thiacyclopentanium trifluoromethanesulfonate,

1-(2-oxooctyl)thiacyclopentanium trifluoromethanesulfonate,

1-(3-methyl-2-oxobutyl)thiacyclopentanium trifluoromethanesulfonate,

1-(3,3-dimethyl-2-oxobutyl)thiacyclopentanium trifluoromethanesulfonate,

1-(2-phenyl-2-oxoethyl)thiacyclopentanium trifluoromethanesulfonate,

1-(2-cyclohexyl-2-oxoethyl)thiacyclopentanium trifluoromethanesulfonate,

1-(2-cyclopentyl-2-oxoethyl)thiacyclopentanium trifluoromethanesulfonate,

1-(2-oxopropyl)thiacyclohexanium trifluoromethanesulfonate,

1-(2-oxobutyl)thiacyclohexanium trifluoromethanesulfonate,

1-(2-oxopentyl)thiacyclohexanium trifluoromethanesulfonate,

1-(2-oxohexyl)thiacyclohexanium trifluoromethanesulfonate,

1-(2-oxoheptyl)thiacyclohexanium trifluoromethanesulfonate,

1-(2-oxooctyl)thiacyclohexanium trifluoromethanesulfonate,

1-(3-methyl-2-oxobutyl)thiacyclohexanium trifluoromethanesulfonate,

1-(3,3-dimethyl-2-oxobutyl)thiacyclohexanium trifluoromethanesulfonate,

1-(2-cyclohexyl-2-oxoethyl)thiacyclohexanium trifluoromethanesulfonate,

1-(2-cyclopentyl-2-oxoethyl)thiacyclohexanium trifluoromethanesulfonate,

1-(2-oxopropyl)-1,4-thioxanium trifluoromethanesulfonate,

1-(2-oxobutyl)-1,4-thioxanium trifluoromethanesulfonate,

1-(2-oxopentyl)-1,4-thioxanium trifluoromethanesulfonate,

1-(2-oxohexyl)-1,4-thioxanium trifluoromethanesulfonate,

1-(2-oxoheptyl)-1,4-thioxanium trifluoromethanesulfonate,

1-(2-oxooctyl)-1,4-thioxanium trifluoromethanesulfonate,

1-(3-methyl-2-oxobutyl)-1,4-thioxanium trifluoromethanesulfonate,

1-(3,3-dimethyl-2-oxobutyl)-1,4-thioxanium trifluoromethanesulfonate,

1-(2-cyclohexyl-2-oxoethyl)-1,4-thioxanium trifluoromethanesulfonate,

1-(2-cyclopentyl-2-oxoethyl)-1,4-thioxanium trifluoromethanesulfonate,

1-(2-oxopropyl)-4-oxothiacyclohexanium trifluoromethanesulfonate,

1-(2-oxobutyl)-4-oxothiacyclohexanium trifluoromethanesulfonate,

1-(2-oxopentyl)-4-oxothiacyclohexanium trifluoromethanesulfonate,

1-(2-oxohexyl)-4-oxothiacyclohexanium trifluoromethanesulfonate,

1-(2-oxoheptyl)-4-oxothiacyclohexanium trifluoromethanesulfonate,

1-(2-oxooctyl)-4-oxothiacyclohexanium trifluoromethanesulfonate,

1-(3-methyl-2-oxobutyl)-4-oxothiacyclohexanium trifluoromethanesulfonate,

1-(3,3-dimethyl-2-oxobutyl)-4-oxothiacyclohexanium trifluoromethanesulfonate,

1-(2-cyclohexyl-2-oxoethyl)-4-oxothiacyclohexanium trifluoromethanesulfonate,

1-(2-cyclopentyl-2-oxoethyl)-4-oxothiacyclohexanium trifluoromethanesulfonate,

1-(2-oxopropyl)-1,4-dithianium trifluoromethanesulfonate,

1-(2-oxobutyl)-1,4-dithianium trifluoromethanesulfonate,

1-(2-oxopentyl)-1,4-dithianium trifluoromethanesulfonate,

1-(2-oxohexyl)-1,4-dithianium trifluoromethanesulfonate,

1-(2-oxoheptyl)-1,4-dithianium trifluoromethanesulfonate,

1-(2-oxooctyl)-1,4-dithianium trifluoromethanesulfonate,

1-(3-methyl-2-oxobutyl)-1,4-dithianium trifluoromethanesulfonate,

1-(3,3-dimethyl-2-oxobutyl)-1,4-dithianium trifluoromethanesulfonate,

1-(2-cyclohexyl-2-oxoethyl)-1,4-dithianium trifluoromethanesulfonate,

1-(2-cyclopentyl-2-oxoethyl)-1,4-dithianium trifluoromethanesulfonate,

1-(2-oxocyclohexyl)thiacyclopentanium trifluoromethanesulfonate,

dimethyl(2-oxopropyl)sulfonium perfluorobutanesulfonate,

dimethyl(2-oxobutyl)sulfonium perfluorobutanesulfonate,

dimethyl(2-oxopentyl)sulfonium perfluorobutanesulfonate,

dimethyl(2-oxohexyl)sulfonium perfluorobutanesulfonate,

dimethyl(2-oxoheptyl)sulfonium perfluorobutanesulfonate,

dimethyl(2-oxooctyl)sulfonium perfluorobutanesulfonate,

dimethyl(3-methyl-2-oxobutyl)sulfonium perfluorobutanesulfonate,

(3,3-dimethyl-2-oxobutyl)dimethylsulfonium perfluorobutanesulfonate,

(2-cyclohexyl-2-oxoethyl)dimethylsulfonium perfluorobutanesulfonate,

(2-cyclopentyl-2-oxoethyl)dimethylsulfonium perfluorobutanesulfonate,

diethyl(2-oxopropyl)sulfonium perfluorobutanesulfonate,

diethyl(2-oxobutyl)sulfonium perfluorobutanesulfonate,

diethyl(2-oxopentyl)sulfonium perfluorobutanesulfonate,

diethyl(2-oxohexyl)sulfonium perfluorobutanesulfonate,

diethyl(2-oxoheptyl)sulfonium perfluorobutanesulfonate,

diethyl(2-oxooctyl)sulfonium perfluorobutanesulfonate,

diethyl(3-methyl-2-oxobutyl)sulfonium perfluorobutanesulfonate,

(3,3-dimethyl-2-oxobutyl)diethylsulfonium perfluorobutanesulfonate,

(2-cyclohexyl-2-oxoethyl)diethylsulfonium perfluorobutanesulfonate,

(2-cyclopentyl-2-oxoethyl)diethylsulfonium perfluorobutanesulfonate,

dibutyl(2-oxopropyl)sulfonium perfluorobutanesulfonate,

dibutyl(2-oxobutyl)sulfonium perfluorobutanesulfonate,

dibutyl(2-oxopentyl)sulfonium perfluorobutanesulfonate,

dibutyl(2-oxohexyl)sulfonium perfluorobutanesulfonate,

dibutyl(2-oxoheptyl)sulfonium perfluorobutanesulfonate,

dibutyl(2-oxooctyl)sulfonium perfluorobutanesulfonate,

dibutyl(3-methyl-2-oxobutyl)sulfonium perfluorobutanesulfonate,

dibutyl(3,3-dimethyl-2-oxobutyl)sulfonium perfluorobutanesulfonate,

dibutyl(2-cyclohexyl-2-oxoethyl)sulfonium perfluorobutanesulfonate,

dibutyl(2-cyclopentyl-2-oxoethyl)sulfonium perfluorobutanesulfonate,

diisopropyl(2-oxopropyl)sulfonium perfluorobutanesulfonate,

diisopropyl(2-oxobutyl)sulfonium perfluorobutanesulfonate,

diisopropyl(2-oxopentyl)sulfonium perfluorobutanesulfonate,

diisopropyl(2-oxohexyl)sulfonium perfluorobutanesulfonate,

diisopropyl(2-oxoheptyl)sulfonium perfluorobutanesulfonate,

diisopropyl(2-oxooctyl)sulfonium perfluorobutanesulfonate,

diisopropyl(3-methyl-2-oxobutyl)sulfonium perfluorobutanesulfonate,

(3,3-dimethyl-2-oxobutyl)diisopropylsulfonium perfluorobutanesulfonate,

(2-cyclohexyl-2-oxoethyl)diisopropylsulfonium perfluorobutanesulfonate,

(2-cyclopentyl-2-oxoethyl)diisopropylsulfonium perfluorobutanesulfonate,

tert-butylmethyl(2-oxopropyl)sulfonium perfluorobutanesulfonate,

tert-butylmethyl(2-oxobutyl)sulfonium perfluorobutanesulfonate,

tert-butylmethyl(2-oxopentyl)sulfonium perfluorobutanesulfonate,

tert-butylmethyl(2-oxohexyl)sulfonium perfluorobutanesulfonate,

tert-butylmethyl(2-oxoheptyl)sulfonium perfluorobutanesulfonate,

tert-butylmethyl(2-oxooctyl)sulfonium perfluorobutanesulfonate,

tert-butylmethyl(3-methyl-2-oxobutyl)sulfonium perfluorobutanesulfonate,

tert-butyl(3,3-dimethyl-2-oxobutyl)methylsulfonium perfluorobutanesulfonate,

tert-butyl(2-cyclohexyl-2-oxoethyl)methylsulfonium perfluorobutanesulfonate,

tert-butyl(2-cyclopentyl-2-oxoethyl)methylsulfonium perfluorobutanesulfonate,

cyclohexylmethyl(2-oxopropyl)sulfonium perfluorobutanesulfonate,

cyclohexylmethyl(2-oxobutyl)sulfonium perfluorobutanesulfonate,

cyclohexylmethyl(2-oxopentyl)sulfonium perfluorobutanesulfonate,

cyclohexylmethyl(2-oxohexyl)sulfonium perfluorobutanesulfonate,

cyclohexylmethyl(2-oxoheptyl)sulfonium perfluorobutanesulfonate,

cyclohexylmethyl(2-oxooctyl)sulfonium perfluorobutanesulfonate,

cyclohexylmethyl(3-methyl-2-oxobutyl)sulfonium perfluorobutanesulfonate,

cyclohexyl(3,3-dimethyl-2-oxobutyl)methylsulfonium perfluorobutanesulfonate,

cyclohexyl(2-cyclohexyl-2-oxoethyl)methylsulfonium perfluorobutanesulfonate,

cyclohexyl(2-cyclopentyl-2-oxoethyl)methylsulfonium perfluorobutanesulfonate,

1-(2-oxopropyl)thiacyclopentanium perfluorobutanesulfonate,

1-(2-oxobutyl)thiacyclopentanium perfluorobutanesulfonate,

1-(2-oxopentyl)thiacyclopentanium perfluorobutanesulfonate,

1-(2-oxohexyl)thiacyclopentanium perfluorobutanesulfonate,

1-(2-oxoheptyl)thiacyclopentanium perfluorobutanesulfonate,

1-(2-oxooctyl)thiacyclopentanium perfluorobutanesulfonate,

1-(3-methyl-2-oxobutyl)thiacyclopentanium perfluorobutanesulfonate,

1-(3,3-dimethyl-2-oxobutyl)thiacyclopentanium perfluorobutanesulfonate,

1-(2-phenyl-2-oxoethyl)thiacyclopentanium perfluorobutanesulfonate,

1-(2-cyclohexyl-2-oxoethyl)thiacyclopentanium perfluorobutanesulfonate,

1-(2-cyclopentyl-2-oxoethyl)thiacyclopentanium perfluorobutanesulfonate,

1-(2-oxopropyl)thiacyclohexanium perfluorobutanesulfonate,

1-(2-oxobutyl)thiacyclohexanium perfluorobutanesulfonate,

1-(2-oxopentyl)thiacyclohexanium perfluorobutanesulfonate,

1-(2-oxohexyl)thiacyclohexanium perfluorobutanesulfonate,

1-(2-oxoheptyl)thiacyclohexanium perfluorobutanesulfonate,

1-(2-oxooctyl)thiacyclohexanium perfluorobutanesulfonate,

1-(3-methyl-2-oxobutyl)thiacyclohexanium perfluorobutanesulfonate,

1-(3,3-dimethyl-2-oxobutyl)thiacyclohexanium perfluorobutanesulfonate,

1-(2-cyclohexyl-2-oxoethyl)thiacyclohexanium perfluorobutanesulfonate,

1-(2-cyclopentyl-2-oxoethyl)thiacyclohexanium perfluorobutanesulfonate,

1-(2-oxopropyl)-1,4-thioxanium perfluorobutanesulfonate,

1-(2-oxobutyl)-1,4-thioxanium perfluorobutanesulfonate,

1-(2-oxopentyl)-1,4-thioxanium perfluorobutanesulfonate,

1-(2-oxohexyl)-1,4-thioxanium perfluorobutanesulfonate,

1-(2-oxoheptyl)-1,4-thioxanium perfluorobutanesulfonate,

1-(2-oxooctyl)-1,4-thioxanium perfluorobutanesulfonate,

1-(3-methyl-2-oxobutyl)-1,4-thioxanium perfluorobutanesulfonate,

1-(3,3-dimethyl-2-oxobutyl)-1,4-thioxanium perfluorobutanesulfonate,

1-(2-cyclohexyl-2-oxoethyl)-1,4-thioxanium perfluorobutanesulfonate,

1-(2-cyclopentyl-2-oxoethyl)-1,4-thioxanium perfluorobutanesulfonate,

1-(2-oxopropyl)-4-oxothiacyclohexanium perfluorobutanesulfonate,

1-(2-oxobutyl)-4-oxothiacyclohexanium perfluorobutanesulfonate,

1-(2-oxopentyl)-4-oxothiacyclohexanium perfluorobutanesulfonate,

1-(2-oxohexyl)-4-oxothiacyclohexanium perfluorobutanesulfonate,

1-(2-oxoheptyl)-4-oxothiacyclohexanium perfluorobutanesulfonate,

1-(2-oxooctyl)-4-oxothiacyclohexanium perfluorobutanesulfonate,

1-(3-methyl-2-oxobutyl)-4-oxothiacyclohexanium perfluorobutanesulfonate,

1-(3,3-dimethyl-2-oxobutyl)-4-oxothiacyclohexanium perfluorobutanesulfonate,

1-(2-cyclohexyl-2-oxoethyl)-4-oxothiacyclohexanium perfluorobutanesulfonate,

1-(2-cyclopentyl-2-oxoethyl)-4-oxothiacyclohexanium perfluorobutanesulfonate,

1-(2-oxopropyl)-1,4-dithianium perfluorobutanesulfonate,

1-(2-oxobutyl)-1,4-dithianium perfluorobutanesulfonate,

1-(2-oxopentyl)-1,4-dithianium perfluorobutanesulfonate,

1-(2-oxohexyl)-1,4-dithianium perfluorobutanesulfonate,

1-(2-oxoheptyl)-1,4-dithianium perfluorobutanesulfonate,

1-(2-oxooctyl)-1,4-dithianium perfluorobutanesulfonate,

1-(3-methyl-2-oxobutyl)-1,4-dithianium perfluorobutanesulfonate,

1-(3,3-dimethyl-2-oxobutyl)-1,4-dithianium perfluorobutanesulfonate,

1-(2-cyclohexyl-2-oxoethyl)-1,4-dithianium perfluorobutanesulfonate,

1-(2-cyclopentyl-2-oxoethyl)-1,4-dithianium perfluorobutanesulfonate,

1-(2-oxocyclohexyl)thiacyclopentanium perfluorobutanesulfonate,

dimethyl(2-oxopropyl)sulfonium perfluorooctanesulfonate,

dimethyl(2-oxobutyl)sulfonium perfluorooctanesulfonate,

dimethyl(2-oxopentyl)sulfonium perfluorooctanesulfonate,

dimethyl(2-oxohexyl)sulfonium perfluorooctanesulfonate,

dimethyl(2-oxoheptyl)sulfonium perfluorooctanesulfonate,

dimethyl(2-oxooctyl)sulfonium perfluorooctanesulfonate,

dimethyl(3-methyl-2-oxobutyl)sulfonium perfluorooctanesulfonate,

(3,3-dimethyl-2-oxobutyl)dimethylsulfonium perfluorooctanesulfonate,

(2-cyclohexyl-2-oxoethyl)dimethylsulfonium perfluorooctanesulfonate,

(2-cyclopentyl-2-oxoethyl)dimethylsulfonium perfluorooctanesulfonate,

diethyl(2-oxopropyl)sulfonium perfluorooctanesulfonate,

diethyl(2-oxobutyl)sulfonium perfluorooctanesulfonate,

diethyl(2-oxopentyl)sulfonium perfluorooctanesulfonate,

diethyl(2-oxohexyl)sulfonium perfluorooctanesulfonate,

diethyl(2-oxoheptyl)sulfonium perfluorooctanesulfonate,

diethyl(2-oxooctyl)sulfonium perfluorooctanesulfonate,

diethyl(3-methyl-2-oxobutyl)sulfonium perfluorooctanesulfonate,

(3,3-dimethyl-2-oxobutyl)diethylsulfonium perfluorooctanesulfonate,

(2-cyclohexyl-2-oxoethyl)diethylsulfonium perfluorooctanesulfonate,

(2-cyclopentyl-2-oxoethyl)diethylsulfonium perfluorooctanesulfonate,

dibutyl(2-oxopropyl)sulfonium perfluorooctanesulfonate,

dibutyl(2-oxobutyl)sulfonium perfluorooctanesulfonate,

dibutyl(2-oxopentyl)sulfonium perfluorooctanesulfonate,

dibutyl(2-oxohexyl)sulfonium perfluorooctanesulfonate,

dibutyl(2-oxoheptyl)sulfonium perfluorooctanesulfonate,

dibutyl(2-oxooctyl)sulfonium perfluorooctanesulfonate,

dibutyl(3-methyl-2-oxobutyl)sulfonium perfluorooctanesulfonate,

dibutyl(3,3-dimethyl-2-oxobutyl)sulfonium perfluorooctanesulfonate,

dibutyl(2-cyclohexyl-2-oxoethyl)sulfonium perfluorooctanesulfonate,

dibutyl(2-cyclopentyl-2-oxoethyl)sulfonium perfluorooctanesulfonate,

diisopropyl(2-oxopropyl)sulfonium perfluorooctanesulfonate,

diisopropyl(2-oxobutyl)sulfonium perfluorooctanesulfonate,

diisopropyl(2-oxopentyl)sulfonium perfluorooctanesulfonate,

diisopropyl(2-oxohexyl)sulfonium perfluorooctanesulfonate,

diisopropyl(2-oxoheptyl)sulfonium perfluorooctanesulfonate,

diisopropyl(2-oxooctyl)sulfonium perfluorooctanesulfonate,

diisopropyl(3-methyl-2-oxobutyl)sulfonium perfluorooctanesulfonate,

(3,3-dimethyl-2-oxobutyl)diisopropylsulfonium perfluorooctanesulfonate,

(2-cyclohexyl-2-oxoethyl)diisopropylsulfonium perfluorooctanesulfonate,

(2-cyclopentyl-2-oxoethyl)diisopropylsulfonium perfluorooctanesulfonate,

tert-butylmethyl(2-oxopropyl)sulfonium perfluorooctanesulfonate,

tert-butylmethyl(2-oxobutyl)sulfonium perfluorooctanesulfonate,

tert-butylmethyl(2-oxopentyl)sulfonium perfluorooctanesulfonate,

tert-butylmethyl(2-oxohexyl)sulfonium perfluorooctanesulfonate,

tert-butylmethyl(2-oxoheptyl)sulfonium perfluorooctanesulfonate,

tert-butylmethyl(2-oxooctyl)sulfonium perfluorooctanesulfonate,

tert-butylmethyl(3-methyl-2-oxobutyl)sulfonium perfluorooctanesulfonate,

tert-butyl(3,3-dimethyl-2-oxobutyl)methylsulfonium perfluorooctanesulfonate,

tert-butyl(2-cyclohexyl-2-oxoethyl)methylsulfonium perfluorooctanesulfonate,

tert-butyl(2-cyclopentyl-2-oxoethyl)methylsulfonium perfluorooctanesulfonate,

cyclohexylmethyl(2-oxopropyl)sulfonium perfluorooctanesulfonate,

cyclohexylmethyl(2-oxobutyl)sulfonium perfluorooctanesulfonate,

cyclohexylmethyl(2-oxopentyl)sulfonium perfluorooctanesulfonate,

cyclohexylmethyl(2-oxohexyl)sulfonium perfluorooctanesulfonate,

cyclohexylmethyl(2-oxoheptyl)sulfonium perfluorooctanesulfonate,

cyclohexylmethyl(2-oxooctyl)sulfonium perfluorooctanesulfonate,

cyclohexylmethyl(3-methyl-2-oxobutyl)sulfonium perfluorooctanesulfonate,

cyclohexyl(3,3-dimethyl-2-oxobutyl)methylsulfonium perfluorooctanesulfonate,

cyclohexyl(2-cyclohexyl-2-oxoethyl)methylsulfonium perfluorooctanesulfonate,

cyclohexyl(2-cyclopentyl-2-oxoethyl)methylsulfonium perfluorooctanesulfonate,

1-(2-oxopropyl)thiacyclopentanium perfluorooctanesulfonate,

1-(2-oxobutyl)thiacyclopentanium perfluorooctanesulfonate,

1-(2-oxopentyl)thiacyclopentanium perfluorooctanesulfonate,

1-(2-oxohexyl)thiacyclopentanium perfluorooctanesulfonate,

1-(2-oxoheptyl)thiacyclopentanium perfluorooctanesulfonate,

1-(2-oxooctyl)thiacyclopentanium perfluorooctanesulfonate,

1-(3-methyl-2-oxobutyl)thiacyclopentanium perfluorooctanesulfonate,

1-(3,3-dimethyl-2-oxobutyl)thiacyclopentanium perfluorooctanesulfonate,

1-(2-phenyl-2-oxoethyl)thiacyclopentanium perfluorooctanesulfonate,

1-(2-cyclohexyl-2-oxoethyl)thiacyclopentanium perfluorooctanesulfonate,

1-(2-cyclopentyl-2-oxoethyl)thiacyclopentanium perfluorooctanesulfonate,

1-(2-oxopropyl)thiacyclohexanium perfluorooctanesulfonate,

1-(2-oxobutyl)thiacyclohexanium perfluorooctanesulfonate,

1-(2-oxopentyl)thiacyclohexanium perfluorooctanesulfonate,

1-(2-oxohexyl)thiacyclohexanium perfluorooctanesulfonate,

1-(2-oxoheptyl)thiacyclohexanium perfluorooctanesulfonate,

1-(2-oxooctyl)thiacyclohexanium perfluorooctanesulfonate,

1-(3-methyl-2-oxobutyl)thiacyclohexanium perfluorooctanesulfonate,

1-(3,3-dimethyl-2-oxobutyl)thiacyclohexanium perfluorooctanesulfonate,

1-(2-cyclohexyl-2-oxoethyl)thiacyclohexanium perfluorooctanesulfonate,

1-(2-cyclopentyl-2-oxoethyl)thiacyclohexanium perfluorooctanesulfonate,

1-(2-oxopropyl)-1,4-thioxanium perfluorooctanesulfonate,

1-(2-oxobutyl)-1,4-thioxanium perfluorooctanesulfonate,

1-(2-oxopentyl)-1,4-thioxanium perfluorooctanesulfonate,

1-(2-oxohexyl)-1,4-thioxanium perfluorooctanesulfonate,

1-(2-oxoheptyl)-1,4-thioxanium perfluorooctanesulfonate,

1-(2-oxooctyl)-1,4-thioxanium perfluorooctanesulfonate,

1-(3-methyl-2-oxobutyl)-1,4-thioxanium perfluorooctanesulfonate,

1-(3,3-dimethyl-2-oxobutyl)-1,4-thioxanium perfluorooctanesulfonate,

1-(2-cyclohexyl-2-oxoethyl)-1,4-thioxanium perfluorooctanesulfonate,

1-(2-cyclopentyl-2-oxoethyl)-1,4-thioxanium perfluorooctanesulfonate,

1-(2-oxopropyl)-4-oxothiacyclohexanium perfluorooctanesulfonate,

1-(2-oxobutyl)-4-oxothiacyclohexanium perfluorooctanesulfonate,

1-(2-oxopentyl)-4-oxothiacyclohexanium perfluorooctanesulfonate,

1-(2-oxohexyl)-4-oxothiacyclohexanium perfluorooctanesulfonate,

1-(2-oxoheptyl)-4-oxothiacyclohexanium perfluorooctanesulfonate,

1-(2-oxooctyl)-4-oxothiacyclohexanium perfluorooctanesulfonate,

1-(3-methyl-2-oxobutyl)-4-oxothiacyclohexanium perfluorooctanesulfonate,

1-(3,3-dimethyl-2-oxobutyl)-4-oxothiacyclohexanium perfluorooctanesulfonate,

1-(2-cyclohexyl-2-oxoethyl)-4-oxothiacyclohexanium perfluorooctanesulfonate,

1-(2-cyclopentyl-2-oxoethyl)-4-oxothiacyclohexanium perfluorooctanesulfonate,

1-(2-oxopropyl)-1,4-dithianium perfluorooctanesulfonate,

1-(2-oxobutyl)-1,4-dithianium perfluorooctanesulfonate,

1-(2-oxopentyl)-1,4-dithianium perfluorooctanesulfonate,

1-(2-oxohexyl)-1,4-dithianium perfluorooctanesulfonate,

1-(2-oxoheptyl)-1,4-dithianium perfluorooctanesulfonate,

1-(2-oxooctyl)-1,4-dithianium perfluorooctanesulfonate,

1-(3-methyl-2-oxobutyl)-1,4-dithianium perfluorooctanesulfonate,

1-(3,3-dimethyl-2-oxobutyl)-1,4-dithianium perfluorooctanesulfonate,

1-(2-cyclohexyl-2-oxoethyl)-1,4-dithianium perfluorooctanesulfonate,

1-(2-cyclopentyl-2-oxoethyl)-1,4-dithianium perfluorooctanesulfonate,

1-(2-oxocyclohexyl)thiacyclopentanium perfluorooctanesulfonate,

dimethyl(2-oxopropyl)sulfonium butanesulfonate,

dimethyl(2-oxobutyl)sulfonium butanesulfonate,

dimethyl(2-oxopentyl)sulfonium butanesulfonate,

dimethyl(2-oxohexyl)sulfonium butanesulfonate,

dimethyl(2-oxoheptyl)sulfonium butanesulfonate,

dimethyl(2-oxooctyl)sulfonium butanesulfonate,

dimethyl(3-methyl-2-oxobutyl)sulfonium butanesulfonate,

(3,3-dimethyl-2-oxobutyl)dimethylsulfonium butanesulfonate,

(2-cyclohexyl-2-oxoethyl)dimethylsulfonium butanesulfonate,

(2-cyclopentyl-2-oxoethyl)dimethylsulfonium butanesulfonate,

diethyl(2-oxopropyl)sulfonium butanesulfonate,

diethyl(2-oxobutyl)sulfonium butanesulfonate,

diethyl(2-oxopentyl)sulfonium butanesulfonate,

diethyl(2-oxohexyl)sulfonium butanesulfonate,

diethyl(2-oxoheptyl)sulfonium butanesulfonate,

diethyl(2-oxooctyl)sulfonium butanesulfonate,

diethyl(3-methyl-2-oxobutyl)sulfonium butanesulfonate,

(3,3-dimethyl-2-oxobutyl)diethylsulfonium butanesulfonate,

(2-cyclohexyl-2-oxoethyl)diethylsulfonium butanesulfonate,

(2-cyclopentyl-2-oxoethyl)diethylsulfonium butanesulfonate,

dibutyl(2-oxopropyl)sulfonium butanesulfonate,

dibutyl(2-oxobutyl)sulfonium butanesulfonate,

dibutyl(2-oxopentyl)sulfonium butanesulfonate,

dibutyl(2-oxohexyl)sulfonium butanesulfonate,

dibutyl(2-oxoheptyl)sulfonium butanesulfonate,

dibutyl(2-oxooctyl)sulfonium butanesulfonate,

dibutyl(3-methyl-2-oxobutyl)sulfonium butanesulfonate,

dibutyl(3,3-dimethyl-2-oxobutyl)sulfonium butanesulfonate,

dibutyl(2-cyclohexyl-2-oxoethyl)sulfonium butanesulfonate,

dibutyl(2-cyclopentyl-2-oxoethyl)sulfonium butanesulfonate,

diisopropyl(2-oxopropyl)sulfonium butanesulfonate,

diisopropyl(2-oxobutyl)sulfonium butanesulfonate,

diisopropyl(2-oxopentyl)sulfonium butanesulfonate,

diisopropyl(2-oxohexyl)sulfonium butanesulfonate,

diisopropyl(2-oxoheptyl)sulfonium butanesulfonate,

diisopropyl(2-oxooctyl)sulfonium butanesulfonate,

diisopropyl(3-methyl-2-oxobutyl)sulfonium butanesulfonate,

(3,3-dimethyl-2-oxobutyl)diisopropylsulfonium butanesulfonate,

(2-cyclohexyl-2-oxoethyl)diisopropylsulfonium butanesulfonate,

(2-cyclopentyl-2-oxoethyl)diisopropylsulfonium butanesulfonate,

tert-butylmethyl(2-oxopropyl)sulfonium butanesulfonate,

tert-butylmethyl(2-oxobutyl)sulfonium butanesulfonate,

tert-butylmethyl(2-oxopentyl)sulfonium butanesulfonate,

tert-butylmethyl(2-oxohexyl)sulfonium butanesulfonate,

tert-butylmethyl(2-oxoheptyl)sulfonium butanesulfonate,

tert-butylmethyl(2-oxooctyl)sulfonium butanesulfonate,

tert-butylmethyl(3-methyl-2-oxobutyl)sulfonium butanesulfonate,

tert-butyl(3,3-dimethyl-2-oxobutyl)methylsulfonium butanesulfonate,

tert-butyl(2-cyclohexyl-2-oxoethyl)methylsulfonium butanesulfonate,

tert-butyl(2-cyclopentyl-2-oxoethyl)methylsulfonium butanesulfonate,

cyclohexylmethyl(2-oxopropyl)sulfonium butanesulfonate,

cyclohexylmethyl(2-oxobutyl)sulfonium butanesulfonate,

cyclohexylmethyl(2-oxopentyl)sulfonium butanesulfonate,

cyclohexylmethyl(2-oxohexyl)sulfonium butanesulfonate,

cyclohexylmethyl(2-oxoheptyl)sulfonium butanesulfonate,

cyclohexylmethyl(2-oxooctyl)sulfonium butanesulfonate,

cyclohexylmethyl(3-methyl-2-oxobutyl)sulfonium butanesulfonate,

cyclohexyl(3,3-dimethyl-2-oxobutyl)methylsulfonium butanesulfonate,

cyclohexyl(2-cyclohexyl-2-oxoethyl)methylsulfonium butanesulfonate,

cyclohexyl(2-cyclopentyl-2-oxoethyl)methylsulfonium butanesulfonate,

1-(2-oxopropyl)thiacyclopentanium butanesulfonate,

1-(2-oxobutyl)thiacyclopentanium butanesulfonate,

1-(2-oxopentyl)thiacyclopentanium butanesulfonate,

1-(2-oxohexyl)thiacyclopentanium butanesulfonate,

1-(2-oxoheptyl)thiacyclopentanium butanesulfonate,

1-(2-oxooctyl)thiacyclopentanium butanesulfonate,

1-(3-methyl-2-oxobutyl)thiacyclopentanium butanesulfonate,

1-(3,3-dimethyl-2-oxobutyl)thiacyclopentanium butanesulfonate,

1-(2-cyclohexyl-2-oxoethyl)thiacyclopentanium butanesulfonate,

1-(2-cyclopentyl-2-oxoethyl)thiacyclopentanium butanesulfonate,

1-(2-oxopropyl)thiacyclohexanium butanesulfonate,

1-(2-oxobutyl)thiacyclohexanium butanesulfonate,

1-(2-oxopentyl)thiacyclohexanium butanesulfonate,

1-(2-oxohexyl)thiacyclohexanium butanesulfonate,

1-(2-oxoheptyl)thiacyclohexanium butanesulfonate,

1-(2-oxooctyl)thiacyclohexanium butanesulfonate,

1-(3-methyl-2-oxobutyl)thiacyclohexanium butanesulfonate,

1-(3,3-dimethyl-2-oxobutyl)thiacyclohexanium butanesulfonate,

1-(2-cyclohexyl-2-oxoethyl)thiacyclohexanium butanesulfonate,

1-(2-cyclopentyl-2-oxoethyl)thiacyclohexanium butanesulfonate,

1-(2-oxopropyl)-1,4-thioxanium butanesulfonate,

1-(2-oxobutyl)-1,4-thioxanium butanesulfonate,

1-(2-oxopentyl)-1,4-thioxanium butanesulfonate,

1-(2-oxohexyl)-1,4-thioxanium butanesulfonate,

1-(2-oxoheptyl)-1,4-thioxanium butanesulfonate,

1-(2-oxooctyl)-1,4-thioxanium butanesulfonate,

1-(3-methyl-2-oxobutyl)-1,4-thioxanium butanesulfonate,

1-(3,3-dimethyl-2-oxobutyl)-1,4-thioxanium butanesulfonate,

1-(2-cyclohexyl-2-oxoethyl)-1,4-thioxanium butanesulfonate,

1-(2-cyclopentyl-2-oxoethyl)-1,4-thioxanium butanesulfonate,

1-(2-oxopropyl)-4-oxothiacyclohexanium butanesulfonate,

1-(2-oxobutyl)-4-oxothiacyclohexanium butanesulfonate,

1-(2-oxopentyl)-4-oxothiacyclohexanium butanesulfonate,

1-(2-oxohexyl)-4-oxothiacyclohexanium butanesulfonate,

1-(2-oxoheptyl)-4-oxothiacyclohexanium butanesulfonate,

1-(2-oxooctyl)-4-oxothiacyclohexanium butanesulfonate,

1-(3-methyl-2-oxobutyl)-4-oxothiacyclohexanium butanesulfonate,

1-(3,3-dimethyl-2-oxobutyl)-4-oxothiacyclohexanium butanesulfonate,

1-(2-cyclohexyl-2-oxoethyl)-4-oxothiacyclohexanium butanesulfonate,

1-(2-cyclopentyl-2-oxoethyl)-4-oxothiacyclohexanium butanesulfonate,

1-(2-oxopropyl)-1,4-dithianium butanesulfonate,

1-(2-oxobutyl)-1,4-dithianium butanesulfonate,

1-(2-oxopentyl)-1,4-dithianium butanesulfonate,

1-(2-oxohexyl)-1,4-dithianium butanesulfonate,

1-(2-oxoheptyl)-1,4-dithianium butanesulfonate,

1-(2-oxooctyl)-1,4-dithianium butanesulfonate,

1-(3-methyl-2-oxobutyl)-1,4-dithianium butanesulfonate,

1-(3,3-dimethyl-2-oxobutyl)-1,4-dithianium butanesulfonate,

1-(2-cyclohexyl-2-oxoethyl)-1,4-dithianium butanesulfonate,

1-(2-cyclopentyl-2-oxoethyl)-1,4-dithianium butanesulfonate,

1-(2-oxocyclohexyl)thiacyclopentanium butanesulfonate,

dimethyl(2-oxopropyl)sulfonium p-toluenesulfonate,

dimethyl(2-oxobutyl)sulfonium p-toluenesulfonate,

dimethyl(2-oxopentyl)sulfonium p-toluenesulfonate,

dimethyl(2-oxohexyl)sulfonium p-toluenesulfonate,

dimethyl(2-oxoheptyl)sulfonium p-toluenesulfonate,

dimethyl(2-oxooctyl)sulfonium p-toluenesulfonate,

dimethyl(3-methyl-2-oxobutyl)sulfonium p-toluenesulfonate,

(3,3-dimethyl-2-oxobutyl)dimethylsulfonium p-toluenesulfonate,

(2-cyclohexyl-2-oxoethyl)dimethylsulfonium p-toluenesulfonate,

(2-cyclopentyl-2-oxoethyl)dimethylsulfonium p-toluenesulfonate,

diethyl(2-oxopropyl)sulfonium p-toluenesulfonate,

diethyl(2-oxobutyl)sulfonium p-toluenesulfonate,

diethyl(2-oxopentyl)sulfonium p-toluenesulfonate,

diethyl(2-oxohexyl)sulfonium p-toluenesulfonate,

diethyl(2-oxoheptyl)sulfonium p-toluenesulfonate,

diethyl(2-oxooctyl)sulfonium p-toluenesulfonate,

diethyl(3-methyl-2-oxobutyl)sulfonium p-toluenesulfonate,

(3,3-dimethyl-2-oxobutyl)diethylsulfonium p-toluenesulfonate,

(2-cyclohexyl-2-oxoethyl)diethylsulfonium p-toluenesulfonate,

(2-cyclopentyl-2-oxoethyl)diethylsulfonium p-toluenesulfonate,

dibutyl(2-oxopropyl)sulfonium p-toluenesulfonate,

dibutyl(2-oxobutyl)sulfonium p-toluenesulfonate,

dibutyl(2-oxopentyl)sulfonium p-toluenesulfonate,

dibutyl(2-oxohexyl)sulfonium p-toluenesulfonate,

dibutyl(2-oxoheptyl)sulfonium p-toluenesulfonate,

dibutyl(2-oxooctyl)sulfonium p-toluenesulfonate,

dibutyl(3-methyl-2-oxobutyl)sulfonium p-toluenesulfonate,

dibutyl(3,3-dimethyl-2-oxobutyl)sulfonium p-toluenesulfonate,

dibutyl(2-cyclohexyl-2-oxoethyl)sulfonium p-toluenesulfonate,

dibutyl(2-cyclopentyl-2-oxoethyl)sulfonium p-toluenesulfonate,

diisopropyl(2-oxopropyl)sulfonium p-toluenesulfonate,

diisopropyl(2-oxobutyl)sulfonium p-toluenesulfonate,

diisopropyl(2-oxopentyl)sulfonium p-toluenesulfonate,

diisopropyl(2-oxohexyl)sulfonium p-toluenesulfonate,

diisopropyl(2-oxoheptyl)sulfonium p-toluenesulfonate,

diisopropyl(2-oxooctyl)sulfonium p-toluenesulfonate,

diisopropyl(3-methyl-2-oxobutyl)sulfonium p-toluenesulfonate,

(3,3-dimethyl-2-oxobutyl)diisopropylsulfonium p-toluenesulfonate,

(2-cyclohexyl-2-oxoethyl)diisopropylsulfonium p-toluenesulfonate,

(2-cyclopentyl-2-oxoethyl)diisopropylsulfonium p-toluenesulfonate,

tert-butylmethyl(2-oxopropyl)sulfonium p-toluenesulfonate,

tert-butylmethyl(2-oxobutyl)sulfonium p-toluenesulfonate,

tert-butylmethyl(2-oxopentyl)sulfonium p-toluenesulfonate,

tert-butylmethyl(2-oxohexyl)sulfonium p-toluenesulfonate,

tert-butylmethyl(2-oxoheptyl)sulfonium p-toluenesulfonate,

tert-butylmethyl(2-oxooctyl)sulfonium p-toluenesulfonate,

tert-butylmethyl(3-methyl-2-oxobutyl)sulfonium p-toluenesulfonate,

tert-butyl(3,3-dimethyl-2-oxobutyl)methylsulfonium p-toluenesulfonate,

tert-butyl(2-cyclohexyl-2-oxoethyl)methylsulfonium p-toluenesulfonate,

tert-butyl(2-cyclopentyl-2-oxoethyl)methylsulfonium p-toluenesulfonate,

cyclohexylmethyl(2-oxopropyl)sulfonium p-toluenesulfonate,

cyclohexylmethyl(2-oxobutyl)sulfonium p-toluenesulfonate,

cyclohexylmethyl(2-oxopentyl)sulfonium p-toluenesulfonate,

cyclohexylmethyl(2-oxohexyl)sulfonium p-toluenesulfonate,

cyclohexylmethyl(2-oxoheptyl)sulfonium p-toluenesulfonate,

cyclohexylmethyl(2-oxooctyl)sulfonium p-toluenesulfonate,

cyclohexylmethyl(3-methyl-2-oxobutyl)sulfonium p-toluenesulfonate,

cyclohexyl(3,3-dimethyl-2-oxobutyl)methylsulfonium p-toluenesulfonate,

cyclohexyl(2-cyclohexyl-2-oxoethyl)methylsulfonium p-toluenesulfonate,

cyclohexyl(2-cyclopentyl-2-oxoethyl)methylsulfonium p-toluenesulfonate,

1-(2-oxopropyl)thiacyclopentanium p-toluenesulfonate,

1-(2-oxobutyl)thiacyclopentanium p-toluenesulfonate,

1-(2-oxopentyl)thiacyclopentanium p-toluenesulfonate,

1-(2-oxohexyl)thiacyclopentanium p-toluenesulfonate,

1-(2-oxoheptyl)thiacyclopentanium p-toluenesulfonate,

1-(2-oxooctyl)thiacyclopentanium p-toluenesulfonate,

1-(3-methyl-2-oxobutyl)thiacyclopentanium p-toluenesulfonate,

1-(3,3-dimethyl-2-oxobutyl)thiacyclopentanium p-toluenesulfonate,

1-(2-cyclohexyl-2-oxoethyl)thiacyclopentanium p-toluenesulfonate,

1-(2-cyclopentyl-2-oxoethyl)thiacyclopentanium p-toluenesulfonate,

1-(2-oxopropyl)thiacyclohexanium p-toluenesulfonate,

1-(2-oxobutyl)thiacyclohexanium p-toluenesulfonate,

1-(2-oxopentyl)thiacyclohexanium p-toluenesulfonate,

1-(2-oxohexyl)thiacyclohexanium p-toluenesulfonate,

1-(2-oxoheptyl)thiacyclohexanium p-toluenesulfonate,

1-(2-oxooctyl)thiacyclohexanium p-toluenesulfonate,

1-(3-methyl-2-oxobutyl)thiacyclohexanium p-toluenesulfonate,

1-(3,3-dimethyl-2-oxobutyl)thiacyclohexanium p-toluenesulfonate,

1-(2-cyclohexyl-2-oxoethyl)thiacyclohexanium p-toluenesulfonate,

1-(2-cyclopentyl-2-oxoethyl)thiacyclohexanium p-toluenesulfonate,

1-(2-oxopropyl)-1,4-thioxanium p-toluenesulfonate,

1-(2-oxobutyl)-1,4-thioxanium p-toluenesulfonate,

1-(2-oxopentyl)-1,4-thioxanium p-toluenesulfonate,

1-(2-oxohexyl)-1,4-thioxanium p-toluenesulfonate,

1-(2-oxoheptyl)-1,4-thioxanium p-toluenesulfonate,

1-(2-oxooctyl)-1,4-thioxanium p-toluenesulfonate,

1-(3-methyl-2-oxobutyl)-1,4-thioxanium p-toluenesulfonate,

1-(3,3-dimethyl-2-oxobutyl)-1,4-thioxanium p-toluenesulfonate,

1-(2-cyclohexyl-2-oxoethyl)-1,4-thioxanium p-toluenesulfonate,

1-(2-cyclopentyl-2-oxoethyl)-1,4-thioxanium p-toluenesulfonate,

1-(2-oxopropyl)-4-oxothiacyclohexanium p-toluenesulfonate,

1-(2-oxobutyl)-4-oxothiacyclohexanium p-toluenesulfonate,

1-(2-oxopentyl)-4-oxothiacyclohexanium p-toluenesulfonate,

1-(2-oxohexyl)-4-oxothiacyclohexanium p-toluenesulfonate,

1-(2-oxoheptyl)-4-oxothiacyclohexanium p-toluenesulfonate,

1-(2-oxooctyl)-4-oxothiacyclohexanium p-toluenesulfonate,

1-(3-methyl-2-oxobutyl)-4-oxothiacyclohexanium p-toluenesulfonate,

1-(3,3-dimethyl-2-oxobutyl)-4-oxothiacyclohexanium p-toluenesulfonate,

1-(2-cyclohexyl-2-oxoethyl)-4-oxothiacyclohexanium p-toluenesulfonate,

1-(2-cyclopentyl-2-oxoethyl)-4-oxothiacyclohexanium p-toluenesulfonate,

1-(2-oxopropyl)-1,4-dithianium p-toluenesulfonate,

1-(2-oxobutyl)-1,4-dithianium p-toluenesulfonate,

1-(2-oxopentyl)-1,4-dithianium p-toluenesulfonate,

1-(2-oxohexyl)-1,4-dithianium p-toluenesulfonate,

1-(2-oxoheptyl)-1,4-dithianium p-toluenesulfonate,

1-(2-oxooctyl)-1,4-dithianium p-toluenesulfonate,

1-(3-methyl-2-oxobutyl)-1,4-dithianium p-toluenesulfonate,

1-(3,3-dimethyl-2-oxobutyl)-1,4-dithianium p-toluenesulfonate,

1-(2-cyclohexyl-2-oxoethyl)-1,4-dithianium p-toluenesulfonate,

1-(2-cyclopentyl-2-oxoethyl)-1,4-dithianium p-toluenesulfonate,

1-(2-oxocyclohexyl)thiacyclopentanium p-toluenesulfonate,

dimethyl(2-oxopropyl)sulfonium camphorsulfonate,

dimethyl(2-oxobutyl)sulfonium camphorsulfonate,

dimethyl(2-oxopentyl)sulfonium camphorsulfonate,

dimethyl(2-oxohexyl)sulfonium camphorsulfonate,

dimethyl(2-oxoheptyl)sulfonium camphorsulfonate,

dimethyl(2-oxooctyl)sulfonium camphorsulfonate,

dimethyl(3-methyl-2-oxobutyl)sulfonium camphorsulfonate,

(3,3-dimethyl-2-oxobutyl)dimethylsulfonium camphorsulfonate,

(2-cyclohexyl-2-oxoethyl)dimethylsulfonium camphorsulfonate,

(2-cyclopentyl-2-oxoethyl)dimethylsulfonium camphorsulfonate,

diethyl(2-oxopropyl)sulfonium camphorsulfonate,

diethyl(2-oxobutyl)sulfonium camphorsulfonate,

diethyl(2-oxopentyl)sulfonium camphorsulfonate,

diethyl(2-oxohexyl)sulfonium camphorsulfonate,

diethyl(2-oxoheptyl)sulfonium camphorsulfonate,

diethyl(2-oxooctyl)sulfonium camphorsulfonate,

diethyl(3-methyl-2-oxobutyl)sulfonium camphorsulfonate,

(3,3-dimethyl-2-oxobutyl)diethylsulfonium camphorsulfonate,

(2-cyclohexyl-2-oxoethyl)diethylsulfonium camphorsulfonate,

(2-cyclopentyl-2-oxoethyl)diethylsulfonium camphorsulfonate,

dibutyl(2-oxopropyl)sulfonium camphorsulfonate,

dibutyl(2-oxobutyl)sulfonium camphorsulfonate,

dibutyl(2-oxopentyl)sulfonium camphorsulfonate,

dibutyl(2-oxohexyl)sulfonium camphorsulfonate,

dibutyl(2-oxoheptyl)sulfonium camphorsulfonate,

dibutyl(2-oxooctyl)sulfonium camphorsulfonate,

dibutyl(3-methyl-2-oxobutyl)sulfonium camphorsulfonate,

dibutyl(3,3-dimethyl-2-oxobutyl)sulfonium camphorsulfonate,

dibutyl(2-cyclohexyl-2-oxoethyl)sulfonium camphorsulfonate,

dibutyl(2-cyclopentyl-2-oxoethyl)sulfonium camphorsulfonate,

diisopropyl(2-oxopropyl)sulfonium camphorsulfonate,

diisopropyl(2-oxobutyl)sulfonium camphorsulfonate,

diisopropyl(2-oxopentyl)sulfonium camphorsulfonate,

diisopropyl(2-oxohexyl)sulfonium camphorsulfonate,

diisopropyl(2-oxoheptyl)sulfonium camphorsulfonate,

diisopropyl(2-oxooctyl)sulfonium camphorsulfonate,

diisopropyl(3-methyl-2-oxobutyl)sulfonium camphorsulfonate,

(3,3-dimethyl-2-oxobutyl)diisopropylsulfonium camphorsulfonate,

(2-cyclohexyl-2-oxoethyl)diisopropylsulfonium camphorsulfonate,

(2-cyclopentyl-2-oxoethyl)diisopropylsulfonium camphorsulfonate,

tert-butylmethyl(2-oxopropyl)sulfonium camphorsulfonate,

tert-butylmethyl(2-oxobutyl)sulfonium camphorsulfonate,

tert-butylmethyl(2-oxopentyl)sulfonium camphorsulfonate,

tert-butylmethyl(2-oxohexyl)sulfonium camphorsulfonate,

tert-butylmethyl(2-oxoheptyl)sulfonium camphorsulfonate,

tert-butylmethyl(2-oxooctyl)sulfonium camphorsulfonate,

tert-butylmethyl(3-methyl-2-oxobutyl)sulfonium camphorsulfonate,

tert-butyl(3,3-dimethyl-2-oxobutyl)methylsulfonium camphorsulfonate,

tert-butyl(2-cyclohexyl-2-oxoethyl)methylsulfonium camphorsulfonate,

tert-butyl(2-cyclopentyl-2-oxoethyl)methylsulfonium camphorsulfonate,

cyclohexylmethyl(2-oxopropyl)sulfonium camphorsulfonate,

cyclohexylmethyl(2-oxobutyl)sulfonium camphorsulfonate,

cyclohexylmethyl(2-oxopentyl)sulfonium camphorsulfonate,

cyclohexylmethyl(2-oxohexyl)sulfonium camphorsulfonate,

cyclohexylmethyl(2-oxoheptyl)sulfonium camphorsulfonate,

cyclohexylmethyl(2-oxooctyl)sulfonium camphorsulfonate,

cyclohexylmethyl(3-methyl-2-oxobutyl)sulfonium camphorsulfonate,

cyclohexyl(3,3-dimethyl-2-oxobutyl)methylsulfonium camphorsulfonate,

cyclohexyl(2-cyclohexyl-2-oxoethyl)methylsulfonium camphorsulfonate,

cyclohexyl(2-cyclopentyl-2-oxoethyl)methylsulfonium camphorsulfonate,

1-(2-oxopropyl)thiacyclopentanium camphorsulfonate,

1-(2-oxobutyl)thiacyclopentanium camphorsulfonate,

1-(2-oxopentyl)thiacyclopentanium camphorsulfonate,

1-(2-oxohexyl)thiacyclopentanium camphorsulfonate,

1-(2-oxoheptyl)thiacyclopentanium camphorsulfonate,

1-(2-oxooctyl)thiacyclopentanium camphorsulfonate,

1-(3-methyl-2-oxobutyl)thiacyclopentanium camphorsulfonate,

1-(3,3-dimethyl-2-oxobutyl)thiacyclopentanium camphorsulfonate,

1-(2-cyclohexyl-2-oxoethyl)thiacyclopentanium camphorsulfonate,

1-(2-cyclopentyl-2-oxoethyl)thiacyclopentanium camphorsulfonate,

1-(2-oxopropyl)thiacyclohexanium camphorsulfonate,

1-(2-oxobutyl)thiacyclohexanium camphorsulfonate,

1-(2-oxopentyl)thiacyclohexanium camphorsulfonate,

1-(2-oxohexyl)thiacyclohexanium camphorsulfonate,

1-(2-oxoheptyl)thiacyclohexanium camphorsulfonate,

1-(2-oxooctyl)thiacyclohexanium camphorsulfonate,

1-(3-methyl-2-oxobutyl)thiacyclohexanium camphorsulfonate,

1-(3,3-dimethyl-2-oxobutyl)thiacyclohexanium camphorsulfonate,

1-(2-cyclohexyl-2-oxoethyl)thiacyclohexanium camphorsulfonate,

1-(2-cyclopentyl-2-oxoethyl)thiacyclohexanium camphorsulfonate,

1-(2-oxopropyl)-1,4-thioxanium camphorsulfonate,

1-(2-oxobutyl)-1,4-thioxanium camphorsulfonate,

1-(2-oxopentyl)-1,4-thioxanium camphorsulfonate,

1-(2-oxohexyl)-1,4-thioxanium camphorsulfonate,

1-(2-oxoheptyl)-1,4-thioxanium camphorsulfonate,

1-(2-oxooctyl)-1,4-thioxanium camphorsulfonate,

1-(3-methyl-2-oxobutyl)-1,4-thioxanium camphorsulfonate,

1-(3,3-dimethyl-2-oxobutyl)-1,4-thioxanium camphorsulfonate,

1-(2-cyclohexyl-2-oxoethyl)-1,4-thioxanium camphorsulfonate,

1-(2-cyclopentyl-2-oxoethyl)-1,4-thioxanium camphorsulfonate,

1-(2-oxopropyl)-4-oxothiacyclohexanium camphorsulfonate,

1-(2-oxobutyl)-4-oxothiacyclohexanium camphorsulfonate,

1-(2-oxopentyl)-4-oxothiacyclohexanium camphorsulfonate,

1-(2-oxohexyl)-4-oxothiacyclohexanium camphorsulfonate,

1-(2-oxoheptyl)-4-oxothiacyclohexanium camphorsulfonate,

1-(2-oxooctyl)-4-oxothiacyclohexanium camphorsulfonate,

1-(3-methyl-2-oxobutyl)-4-oxothiacyclohexanium camphorsulfonate,

1-(3,3-dimethyl-2-oxobutyl)-4-oxothiacyclohexanium camphorsulfonate,

1-(2-cyclohexyl-2-oxoethyl)-4-oxothiacyclohexanium camphorsulfonate,

1-(2-cyclopentyl-2-oxoethyl)-4-oxothiacyclohexanium camphorsulfonate,

1-(2-oxopropyl)-1,4-dithianium camphorsulfonate,

1-(2-oxobutyl)-1,4-dithianium camphorsulfonate,

1-(2-oxopentyl)-1,4-dithianium camphorsulfonate,

1-(2-oxohexyl)-1,4-dithianium camphorsulfonate,

1-(2-oxoheptyl)-1,4-dithianium camphorsulfonate,

1-(2-oxooctyl)-1,4-dithianium camphorsulfonate,

1-(3-methyl-2-oxobutyl)-1,4-dithianium camphorsulfonate,

1-(3,3-dimethyl-2-oxobutyl)-1,4-dithianium camphorsulfonate,

1-(2-cyclohexyl-2-oxoethyl)-1,4-dithianium camphorsulfonate,

1-(2-cyclopentyl-2-oxoethyl)-1,4-dithianium camphorsulfonate,

1-(2-oxocyclohexyl)thiacyclopentanium camphorsulfonate,

In the formula (IIa), P¹, P² and P³ each independently represent hydrogen, hydroxyl, alkyl having 1 to 6 carbon atoms or alkoxy having 1 to 6 carbon atoms, and the alkyl and alkoxy may be linear or branched in the case of 3 or more carbon atoms.

In the formula (IIb), P⁴ and P⁵ each independently represent hydrogen, hydroxyl, alkyl having 1 to 6 carbon atoms or alkoxy having 1 to 6 carbon atoms, and the alkyl and alkoxy may be linear or branched in the case of 3 or more carbon atoms.

In P¹, P², P³, P⁴ and P⁵, specific examples of the alkyl include methyl, ethyl, propyl, isopropyl, butyl, tert-butyl, pentyl, hexyl and the like, and examples of the alkoxy include methoxy, ethoxy, propoxy, butoxy and the like.

P⁶SO₃⁻ in the formula (IIa) and P⁷SO₃⁻ in the formula (IIb) each independently represent organic sulfonate ion. P⁶ and P⁷ may be an organic group having 1 to about 12 carbon atoms. Examples thereof include alkyl having 1 to 8 carbon atoms such as methyl, ethyl, propyl, isopropyl, butyl, pentyl, hexyl, heptyl, and the like; perfluoroalkyl having 1 to 8 carbon atoms such as trifluoromethyl, perfluorobuthyl, perfluorooctyl, and the like; cycloalkyl such as cyclopentyl, cyclohexyl, and the like; aromatic group having 6 to 12 carbon atoms such as phenyl, tolyl, xylyl, mesityl, naphtyl, and the like; camphor group, and the like.

Specific examples of (b) salt include the followings:

triphenylsulfonium methanesulfonate,

triphenylsulfonium ethanesulfonate,

triphenylsulfonium butanesulfonate,

triphenylsulfonium perfluorobutanesulfonate,

triphenylsulfonium p-toluenesulfonate,

triphenylsulfonium camphorsulfonate,

4-methylphenyldiphenylsulfonium methanesulfonate,

4-methylphenyldiphenylsulfonium ethanesulfonate,

4-methylphenyldiphenylsulfonium butanesulfonate,

4-methylphenyldiphenylsulfonium benzenesulfonate,

4-methylphenyldiphenylsulfonium p-toluenesulfonate,

4-methylphenyldiphenylsulfonium camphorsulfonate,

4-methylphenyldiphenylsulfonium perfluorooctanesulfonate,

4-hydroxyphenyldiphenylsulfonium perfluorobutanesulfonate,

4-methoxyphenyldiphenylsulfonium perfluorobutanesulfonate,

tris(4-methylphenyl)sulfonium perfluorobutanesulfonate,

tri(4-methoxylphenyl)sulfonium perfluorobutanesulfonate,

4-hydroxyphenyldiphenylsulfonium perfluorooctanesulfonate,

tris(4-methylphenyl)sulfonium perfluorooctanesulfonate,

tri(4-methoxylphenyl)sulfonium perfluorooctanesulfonate,

diphenyliodonium perfluorobutanesulfonate,

di(4-methoxyphenyl)iodonium perfluorooctanesulfonate,

di(4-tert-butylphenyl)iodonium perfluorooctanesulfonate,

di(4-tert-butylphenyl)iodonium methanesulfonate,

di(4-tert-butylphenyl)iodonium ethanesulfonate,

di(4-tert-butylphenyl)iodonium butanesulfonate,

di(4-tert-butylphenyl)iodonium benzenesulfonate,

di(4-tert-butylphenyl)iodonium p-tolueneulfonate,

di(4-tert-butylphenyl)iodonium camphorsulfonate,

Next, the resin contained in the present resist composition is explained.

In the present resist composition, the content of halogen atoms in the resin is 40% by weight or more, at least one of structural units constituting the resin is a structural unit having an alicyclic hydrocarbon skeleton, and the structural unit having an alicyclic hydrocarbon skeleton contains therein at least one group rendering the resin soluble in an alkali aqueous solution by the action of an acid, and the structural unit having an alicyclic hydrocarbon skeleton contains therein at least one halogen atom. A carbon atom in the alicyclic hydrocarbon skeleton may be substituted by an oxygen.

In the present invention, the term skeleton means a basic frame of a molecule or a group and represents a frame symbolized by removing hydrogen atoms and/or possible substituents from the structural formula with exception of the part(s) particularly manifested explicitly. Therefore, when hydrogen atom(s) or substituent(s) is(are) specified particularly in a skeleton, other unspecified parts indicate a frame. The alicyclic hydrocarbon skeleton includes a cycloalkane skeleton and the like. The term alicyclic hydrocarbon ring used in the present invention has the same, but more specific meaning as for the term alicyclic hydrocarbon skeleton (sometimes used for avoiding confusion).

As the alicyclic hydrocarbon skeleton, skeletons of the following formula (1) can be listed.

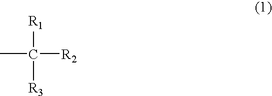

wherein R₂ and R₃ bond to form an alicyclic hydrocarbon ring together with adjacent C (carbon atom), the alicyclic hydrocarbon ring formed by R₂, R₃ and C bonds to at least one group containing a group rendering a resin soluble in an alkali aqueous solution by the action of an acid, and bonds to at least one halogen atom; R₁ represents a hydrogen atom, halogen atom or aliphatic hydrocarbon group.

As the alicyclic hydrocarbon ring formed by R₂, R₃ and C, a cyclopentane ring, cyclohexane ring and the like can be listed. As the halogen atom, a fluorine atom is preferable. As the group containing a group rendering a resin soluble in an alkali aqueous solution by the action of an acid, —OR₈ group described later, alkoxyalkyl group optionally substituted with at least one halogen atom, alkoxyalkoxyalkyl group optionally substituted with at least one halogen atom, and the like can be listed.

Specific examples of the alicyclic hydrocarbon skeleton of the formula (1), listed are alicyclic hydrocarbon skeletons of the (2):

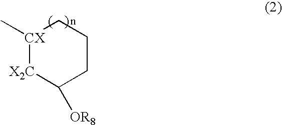

wherein X represents a halogen atom, R₈ represents a hydrogen atom or an acid-unstable group dissociating in the presence of an acid, and n represents 0 or 1;

alicyclic hydrocarbon skeletons of the (6):

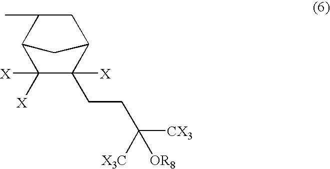

wherein X and R₈ have the same meanings as described above; and the like.

Further, other example of the alicyclic hydrocarbon skeleton is a skeleton containing a partial structure of the following formula (3):

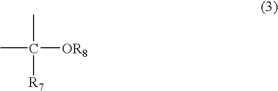

wherein C is a carbon atom forming an alicyclic hydrocarbon skeleton; R₇ represents an alkyl group having 1 to 6 carbon atoms substituted with at least one halogen atom or alicyclic hydrocarbon group substituted with at least one halogen atom; and R₈ has the same meaning as described above.

Examples of the alkyl group having 1 to 6 carbon atoms substituted with at least one halogen atom are fluoromethyl group, difluoromethyl group, trifluoromethyl group, 2,2,2-trifluoroethyl group, perfluoroethyl group, —C(CF₃)₃ group, and the like. This alkyl group may be straight chained or branched.

Examples of the alicyclic hydrocarbon group substituted with at least one halogen atom are perfluorocyclopentyl group, perfluorocyclohexyl group, and the like.

Specific examples of the skeleton containing a partial structure of the formula (3) as the alicyclic hydrocarbon skeleton, are alicyclic hydrocarbon skeleton of the formula (4):

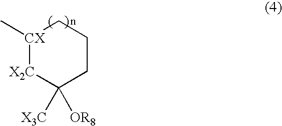

wherein X, R₈ and n have the same meanings as described above, and the like.

Examples of R₈ are a group of the formula (5):

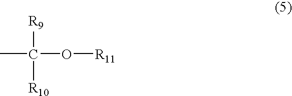

wherein R₉ and R₁₀ each independently represent an alkyl group having 1 to 14 carbon atoms or a hydrogen atom, the alkyl group may have at least one group selected from the group consisting of halogen atoms and alicyclic hydrocarbon groups; R₁₁ represents an alkyl group having 1 to 14 carbon atoms, alicyclic hydrocarbon group, lactone ring group or aromatic hydrocarbon group, the alkyl group may have at least one substituent selected from the group consisting of halogen atom, alicyclic hydrocarbon group and aromatic hydrocarbon group, the alicyclic hydrocarbon group, lactone ring group and aromatic hydrocarbon group in R₁₁ may each independently have at least one substituent selected from the group consisting of halogen atoms and alkyl groups.

Specific examples of R⁸ include acetal type group such as 1-ethoxyethyl group, 1-(2-methylpropoxy)ethyl group, 1-(2-methoxyethoxy)ethyl group, 1-(2-acetoxyethoxy)ethyl group, 1-[2-(1-adamantyloxy)ethoxy]ethyl group, 1-[2-(1-adamantanecarbonyloxy)ethoxy]ethyl group, adamantyloxymethyl group, bicyclohexyloxymethyl group, adamantylmethoxymethyl group, methoxymethyl group, ethoxymethyl group, pivaloyloxymethyl group, methoxyethoxymethyl group, benzyloxymethyl group, di(trifluoromethyl)methoxymethyl group, and the like.

Particularly because of easy availability and easy synthesis, methoxymethyl group and ethoxymethyl group are preferably used.

The acid-unstable group dissociating in the presence of an acid is substituted with a hydrogen atom to become an alkali soluble group by the action of an acid.

The acid-unstable group dissociating in the presence of an acid (R₈) can be easily introduced into a resin by performing a known protective group introducing reaction or conducting polymerization using as one monomer an unsaturated compound having such a group.

In the above-mentioned formula (3), it is preferable that R₇ is trifluoromethyl group since the transmittance of vacuum ultraviolet ray typified by 157 nm of resin composition increases.

Examples of the group having an alicyclic hydrocarbon skeleton of the formula (1), for example are alicyclic hydrocarbon groups in which carbon atoms forming the skeleton bond to hydrogen atoms, excepting portions bonded to a halogen atom or a group containing a group rendering a resin soluble in an alkali aqueous solution by the action of an acid; and alicyclic hydrocarbon groups in which at least one hydrogen atom bonding to a carbon atom is substituted with a (halo)alkyl group.

Examples of the structural unit having an alicyclic hydrocarbon skeleton of the formula (1), are structural units of the following formulae (8), (9), (10) and the like.

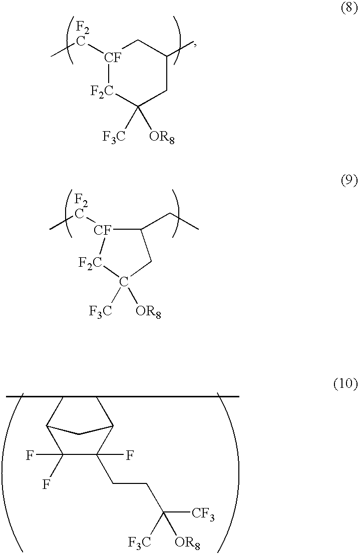

The resin used in the present invention can be obtained by polymerization according to a known polymerization reaction. Namely, a monomer capable of inducing the above-mentioned structural unit, and an initiator can be mixed and stirred at suitable temperature, in the presence or absence of a solvent, to effect the polymerization. A catalyst may be mixed, if necessary. The resulted polymer can be precipitated in a suitable solvent, for purification.

The resin in the present resist composition may be a resin substantially consisting of a structural unit having an alicyclic hydrocarbon skeleton and containing therein at least one group rendering the resin soluble in an alkali aqueous solution by the action of an acid, and at least one halogen atom. However, usually used are copolymers of the above-mentioned structural unit with the same structural unit as the above-mentioned structural unit excepting that a group rendering the resin soluble in an alkali aqueous solution by the action of an acid is not contained, namely, a group rendering the resin soluble in an alkali aqueous solution even without the action of an acid is contained. Specific example thereof is structural units of the above-mentioned formulas (8), (9) and (10) in which —OR₈ group is substituted by OH group.

Specifically listed are a copolymer composed of a structural unit of the formula:

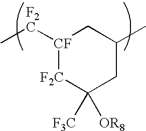

and a structural unit of the formula:

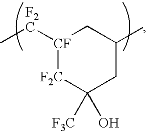

a copolymer composed of a structural unit of the formula:

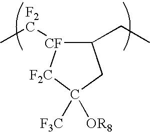

and a structural unit of the formula:

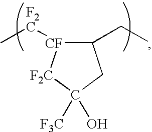

a copolymer composed of a structural unit of the formula:

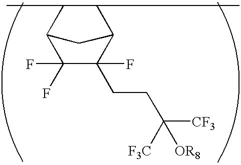

and a structural unit of the formula:

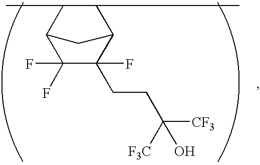

mixtures of these copolymers, and the like.

More specific examples thereof include a copolymer composed of a

structural unit of the formula:

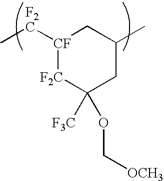

and a structural unit of the formula:

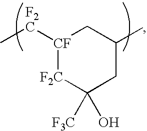

a copolymer composed of a structural unit of the formula:

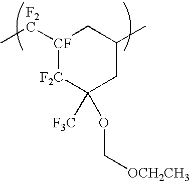

and a structural unit of the formula:

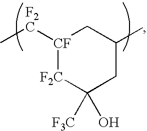

a copolymer composed of a structural unit of the formula:

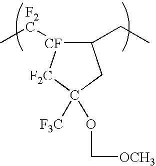

and a structural unit of the formula:

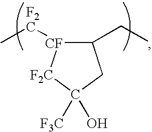

a copolymer composed of a structural unit of the formula:

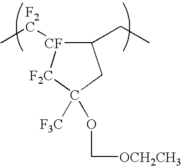

and a structural unit of the formula:

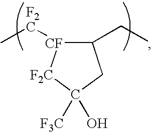

a copolymer composed of a structural unit of the formula:

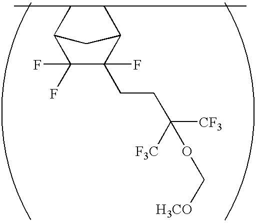

and a structural unit of the formula:

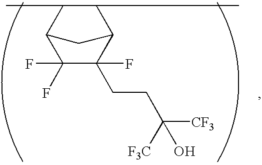

a copolymer composed of a structural unit of the formula:

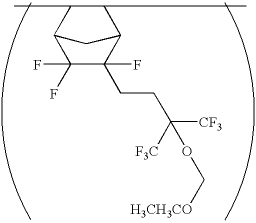

and a structural unit of the formula:

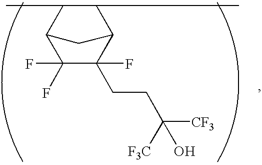

mixtures of these copolymers, and the like.

Besides, a copolymer composed of structural units of the formulae:

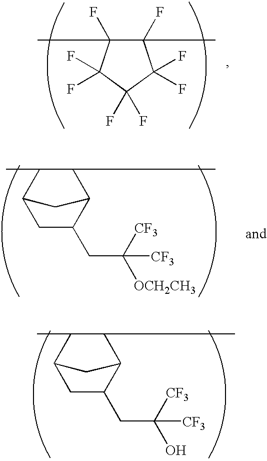

are also listed.

The resin use in the present invention contains halogen atoms in an amount of 40% by weight or more in the resin. Though varying depending on the kind of radiation for patterning exposure, the kind of a group dissociating by the action of an acid, and the like, it is generally preferable that the content of the structural unit having an alicyclic hydrocarbon skeleton which contains therein at least one group rendering the resin soluble in an alkali aqueous solution by the action of an acid, and at least one halogen atom, is 15 to 50 mol % in the total structural units in the resin.

In the present composition, performance deterioration caused by inactivation of acid which occurs due to post exposure delay can be diminished by adding basic compounds, particularly, basic nitrogen-containing organic compounds, for example, amines as a quencher.

Specific examples of such basic nitrogen-containing organic compounds include the ones represented by the following formulae:

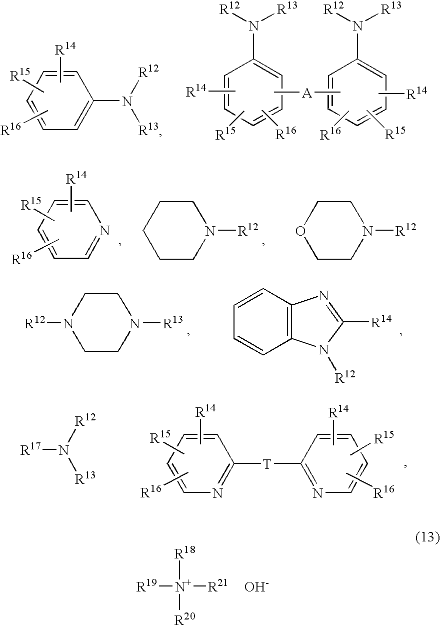

Wherein R₁₂ and R¹³ represent each independently hydrogen, alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted by hydroxyl, amino, or alkoxy having 1 to 6 carbon atoms. At least one hydrogen on the amino may each independently be substituted by alkyl having 1 to 4 carbon atoms.

R¹⁴, R¹⁵ and R₁₆ each independently represent hydrogen, alkyl cycloalkyl, aryl or alkoxy. The alkyl preferably has about 1 to 6 carbon atoms, the cycloalkyl preferably has about 5 to 10 carbon atoms, the aryl preferably has about 6 to 10 carbon atoms, and the alkoxy preferably has about 1 to 6 carbon atoms. Furthermore, at least one hydrogen on the alkyl, cycloalkyl, aryl or alkoxy may each independently be substituted by hydroxyl, amino, or alkoxy having 1 to 6 carbon atoms. At least one hydrogen on the amino may be substituted by alkyl having 1 to 4 carbon atoms.

R¹⁷ represents alkyl or cycloalkyl. The alkyl preferably has about 1 to 6 carbon atoms, and the cycloalkyl preferably has about 5 to 10 carbon atoms. Furthermore, at least one hydrogen on the alkyl or cycloalkyl may each independently be substituted by hydroxyl, amino, or alkoxy having 1 to 6 carbon atoms. At least one hydrogen on the amino may be substituted by alkyl having 1 to 4 carbon atoms.

R¹⁸, R¹⁹, R²⁰ and R²¹ each independently represent alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted by hydroxyl, amino, or alkoxy having 1 to 6 carbon atoms. At least one hydrogen on the amino may each independently be substituted by alkyl having 1 to 4 carbon atoms.

T represents alkylene, carbonyl, imino, sulfide or disulfide. The alkylene preferably has about 2 to 6 carbon atoms.

Moreover, among R¹²-R²¹, in regard to those which can be straight-chained or branched, either of these may be permitted.

Examples of such compounds include hexylamine, heptylamine, octylamine, nonylamine, decylamine, aniline, 2-, 3- or 4-methylaniline, 4-nitroaniline, 1- or 2-naphtylamine, ethylenediamine, tetramethylenediamine, hexamethylenediamine, 4,4′-diamino-1,2-diphenylethane, 4,4′-diamino-3,3′-dimethyldiphenylmethane, 4,4′-diamino-3,3′-diethyldiphenylmethane, dibutylamine, dipentylamine, dihexylamine, diheptylamine, dioctylamine, dinonylamine, didecylamine, N-methylaniline, piperidine, diphenylamine, triethylamine, trimethylamine, tripropylamine, tributylamine, tripentylamine, trihexylamine, trihexylamine, triheptylamine, trioctylamine, trinonylamine, tridecylamine, methyldibutylamine, methyldipentylamine, methyldihexylamine, methyldicyclohexylamine, methyldiheptylamine, methyldioctylamine, methyldinonylamine, methyldidecylamine, ethyldibutylamine, ethydipentylamine, ethyldihexylamine, ethydiheptylamine, ethyldioctylamine, ethyldinonylamine, ethyldidecylamine, dicyclohexylmethylamine, tris[2-(2-methoxyethoxy)ethyl]amine, triisopropanolamine, N,N-dimethylaniline, 2,6-isopropylaniline, imidazole, pyridine, 4-methylpyridine, 4-methyimidazole, bipyridine, 2,2′-dipyridylamine, di-2-pyridyl ketone, 1,2-di(2-pyridyl)ethane, 1,2-di(4-pyridyl)ethane, 1,3-di(4-pyridyl)propane, 1,2-bis(2-pyridyl)ethylene, 1,2-bis(4-pyridyl)ethylene, 1,2-bis(4-pyridyloxy)ethane, 4,4′-dipyridyl sulfide, 4,4′-dipyridyl disulfide, 1,2-bis(4-pyridyl)ethylene, 2,2′-dipicolylamine, 3,3′-dipicolylamine, tetramethylammonium hydroxide, tetraisopropylammonium hydroxide, tetrabutylammonium hydroxide, tetra-n-hexylammonium hydroxide, tetra-n-octylammonium hydroxide, phenyltrimethylammonium hydroxide, 3-trifluoromethylphenyltrimethylammonium hydroxide, (2-hydroxyethyl)trimethylammonium hydroxide (so-called “choline”), and the like.

Furthermore, hindered amine compounds having piperidine skeleton as disclosed in JP-A-H11-52575 can be used as quencher.

From the viewpoint of the development of the resolution, it is preferred to use the compound represented by the formula (13) as a quencher.

It is preferable that the present composition contains resin in an amount of about 80 to 99.9% by weight and the acid generator in an amount of 0.1 to 20% by weight based on the total solid content of the present composition. The weight ratio (b) salt to (a) salt is usually9 to 1/9, preferably 4 to 1/4.

When basic compound is used as a quencher, it is preferable that the basic compound is contained in an amount of about 0.01 to 1% by weight based on the total solid content of the present composition.

The present composition can contain, if necessary, various additives in small amount such as a sensitizer, solution suppressing agent, other resins, surfactant, stabilizer, dye and the like, as long as the effect of the present invention is not prevented.

The present composition is usually in the form of a resist liquid composition in which the aforementioned ingredients are dissolved in a solvent, and the resist liquid composition is to be applied onto a substrate such as a silicon wafer by a conventional process such as spin coating. The solvent used here is sufficient to dissolve the aforementioned ingredients, have an adequate drying rate, and give a uniform and smooth coat after evaporation of the solvent and, hence, solvents generally used in the art can be used. In the present invention, the total solid content means total content exclusive of solvents.

Examples thereof include glycol ether esters such as ethylcellosolve acetate, methylcellosolve acetate and propylene glycol monomethyl ether acetate; esters such as ethyl lactate, butyl lactate, amyl lactate and ethyl pyruvate and the like; ketones such as acetone, methyl isobutyl ketone, 2-heptanone and cyclohexanone; cyclic esters such as γ-butyrolactone, and the like. These solvents can be used each alone or in combination of two or more.

A resist film applied onto the substrate and then dried is subjected to exposure for patterning, then heat-treated for facilitating a deblocking reaction, and thereafter developed with an alkali developer. The alkali developer used here may be any one of various alkaline aqueous solutions used in the art, and generally, an aqueous solution of tetramethylammonium hydroxide or (2-hydroxyethyl)trimethylammonium hydroxide (commonly known as “choline”) is often used.

The present invention will be described more specifically by way of examples, which are not construed to limit the scope of the present invention. The “%” and “part(s)” used to represent the content of any component and the amount of any material used in the following examples are on a weight basis unless otherwise specifically noted. The weight-average molecular weight of any material used in the following examples is a value found by gel permeation chromatography using styrene as a standard reference material.

Acid generator synthesis example 1: Synthesis of acid generator B1

0(1) Into a flask was charged 70.17 parts of tetrahydrothiophene and 750 parts of acetone. To the solution was added dropwise 150 parts of bromopinacolone, and then the mixture was stirred for 24 hours at a room temperature. The crystals deposited were filtrated and washed with 100 parts of tert-butyl methyl ether, and then dried to obtain 161.3 parts of 1-(3,3-dimethyl-2oxobutyl)thiacyclopentanium bromide.

(2) Into a flask were charged 80 parts of 1-(3,3-dimethyl-2oxobutyl)thiacyclopentanium bromide and 3200 parts of acetonitrile, and then to the solution was added dropwise potassium trifluoromethanesulfonate, and the mixture was stirred at a room temperature for 18 hours. After potassium bromide deposited was filtered out from the resulting mixture, the filtrate was concentrated. To the concentrate was added acetone, then to tert-butyl methyl ether was added the acetone solution of the concentrate to obtain 94.73 parts of intended product. It was confirmed that the product was 1-(3,3-dimethyl-2-oxobutyl)thiacyclopentanium trifluoromethanesulfonate shown by the following formula by ¹H-NMR (“GX-70 made by Japan Eectron Optics Laboratory Co., Ltd.).

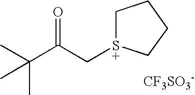

¹H-NMR (chloroform-d, Internal Standard: tetramethylsilane): δ (ppm) 1.24 (s, 9H);2.26-2.33 (m, 2H); 2.42-2.52 (m, 2H); 3.45-3.55 (m, 2H); 3.61-3.71 (m, 2H); 4.96 (s, 2H)

### EXAMPLE 1 AND COMPARATIVE EXAMPLE 1

The following components were mixed and dissolved, further, filtrated through a fluorine resin filter having pore diameter of 0.2 μm, to prepare resist liquid.

Resin

Resin A: 10 parts

Resin A: an equivalent weight mixture of resin (a1) and resin (a2)

resin (a1): having the following structure and weight average molecular weight of 12000 and fluoride content of 49.3%

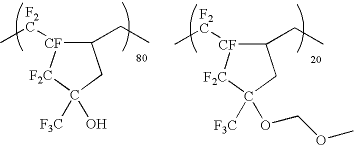

(Methoxymethylation ratio was measured by ¹H NMR)

resin (a2): having the following structure and weight average molecular weight of 12900 and fluoride content of 48.7%

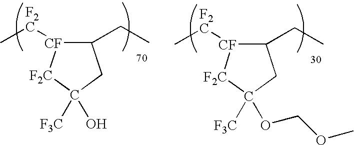

(Methoxymethylation ratio was measured by ¹H NMR)

Acid generator (kind and amount are described in Table 1)

Acid Generator B: 1-(3,3-dimethyl-2-oxobutyl)thiacyclopentanium trifluorometanesulfonate

Acid Generator C: (4-methylphenyl)diphenylsulfonium trifluoromethanesulfonate

Quencher

Tri-n-octylamine: 0.04 part

Solvent

propyleneglycol monomethyl ether acetate: 95 parts

γ-butyrolactone: 5 parts

The resist solution prepared above was spin-coated on a silicon wafer carrying thereon an organic reflection prevention membrane having a thickness of 1600 Å formed by applying “DUV-30J” which is organic reflection prevention membrane composition manufactured by Brewer, and baking it under conditions of 21 5° C. and 60 seconds, so that the membrane thickness after drying was 0.19 μm. The silicon wafers thus coated with the respective resist liquids were each prebaked on a direct hotplate at temperature shown in “PB” column in Table 1 for 60 seconds. Using an ArF excimer stepper (“NSR ArF” manufactured by Nikon Corporation, NA=0.55, 2/3 Annular), each wafer thus formed with the respective resist film was subjected to line and space pattern exposure, with the exposure quantity being varied stepwise.

After the exposure, each wafer was subjected to post-exposure baking on a hotplate at temperature shown in “PEB” column in Table 1 for 60 seconds and then to paddle development for 60 seconds with an aqueous solution of 2.3 8 wt % tetramethylammonium hydroxide.

The line and space patterns after development were observed by a scanning electron microscope, methods, and the effective sensitivity and the resolution thereof were evaluated. The results are shown in Table 1.

Effective sensitivity: It is expressed as the amount of exposure that the line pattern and the space pattern become 1:1 after exposure through 0.15 μm line and space pattern mask and development.

Resolution: It is expressed as the minimum size of space pattern which gave the space pattern split by the line pattern at the exposure amount of the effective sensitivity.

On the other hand, the resist solution prepared above was spin-coated on a magnesium fluoride wafer so that the membrane thickness after drying was 0.1 μm, and baking it under the same conditions above. Transmittance of each of the resist membrane thus obtained at the wavelength of 157 nm was analyzed by using vacuum ultraviolet spectroscopic meter (VUV-200 made by JASCO Corporation). The results are shown in Table 1.

TABLE 1

| | | Acid | | | E.S.^{#1} | Res. ^{#2} | |
|---|---|---|---|---|---|---|---|
| | | Generator | PB | PEB | (D/B)^{#4} | (D/B)^{#4} | TM^{#3} |
| Exp. No. | Resin | (Part) | (° C.) | (° C.) | mJ/cm² | μm | (%) |
| Exp. 1 | A | C(0.5) | 110 | 100 | 10/7 | 0.14/0.13 | 82.2 |
| | | B(0.25) | | | | | |
| Comp. | A | C(0.5) | 110 | 110 | 12/7.5 | 0.14/0.14 | 85.1 |
| Exp. 1 | | | | | | | |

^{#1}Effective Sensitivity (Dark/Bright)
^{#2}Resolution (Dark/Bright)
^{#3}Transmittance at 157 nm
^{#4}(Dark/Bright)

The positive resist composition of the present invention gives resist membrane which is excellent in transmittance at wavelengths of 157 nm and has good balance in various properties. Therefore, the composition shows excellent properties as a resist for F2 laser.

What is claimed is:

1. A positive resist composition comprising
(A) a resin which itself is insoluble or poorly soluble in an alkali aqueous solution but becomes soluble in an alkali aqueous solution by the action of an acid, wherein the content of halogen atoms in the resin is 40% by weight or more, at least one of structural units constituting the resin is a structural unit having an alicyclic hydrocarbon skeleton, and the structural unit having an alicyclic hydrocarbon skeleton contains therein at least one group rendering the resin soluble in an alkali aqueous solution by the action of an acid, and at least one halogen atom, and a carbon in the alicyclic hydrocarbon skeleton may be substituted by an oxygen, and
(B) (a) an acid generator comprising a sulfonium salt of the formula (I) 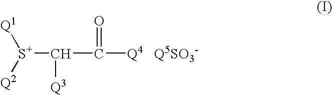
wherein Q¹ and Q² each independently represent alkyl having 1 to 6 carbon atoms or cycloalkyl having 3 to 10 carbon atoms, or Q¹ and Q² bond to form divalent acyclic hydrocarbon having 3 to 7 carbon atoms which form a ring together with the adjacent S⁺, and at least one —CH₂— in the divalent acyclic hydrocarbon may be substituted by —CO—, —O— or —S—; Q³ represent hydrogen, Q⁴ represents alkyl having 1 to 6 carbon atoms, cycloalkyl having 3 to 10 carbon atoms or phenyl optionally substituted by alkyl having 1 to 6 carbon atoms, or Q³ and Q⁴ bond to form 2-oxocycloalkyl together with the adjacent —CHCO—, and
Q⁵SO₃⁻ represents organic sulfonate ion, and
(b) at least one onium salt selected from the group consisting of a triphenylsulfonium salt of the formula (IIa) and a diphenyliodonium salt of the formula (IIb) 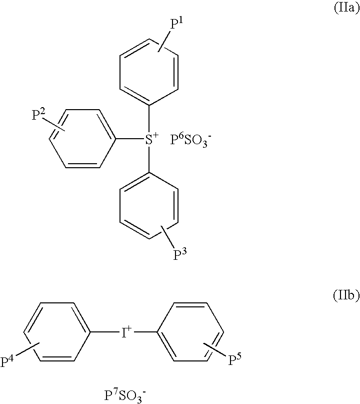
wherein P¹, P², P³, P⁴ and P⁵ each independently represent hydrogen, hydroxyl, alkyl having 1 to 6 carbon atoms or alkoxy having 1 to 6 carbon atoms, and P⁶SO₃⁻ and P⁷SO₃⁻ each independently represent organic sulfonate ion.

2. The positive resist composition according to claim 1 wherein Q¹ and Q² bond to form divalent acyclic hydrocarbon having 3 to 7 carbon atoms which form a ring together with the adjacent S⁺, and at least one —CH₂— in the divalent acyclic hydrocarbon may be substituted by —CO—, —O— or —S—.

3. The positive resist composition according to claim 1 wherein Q⁵, P⁶ and P⁷ each independently represent alkyl having 1 to 8 carbon atoms, perfluoroalkyl having 1 to 8 carbon atoms, aromatic group having 6 to 12 carbon atoms or camphor group.

4. The positive resist composition according to claim 1 wherein the weight ratio of (b)/(a) is 9 to 1/9 wherein (a) is a sulfonium salt of the formula (I), and (b) is at least one onium salt selected by from the group consisting of a triphenylsulfonium salt of the formula (IIa) and diphenyliodonium salt of the formula (IIb).

5. The positive resist composition according to claim 1 wherein the content of the structural unit having an alicyclic hydrocarbon skeleton which contains therein at least one group rendering the resin soluble in an alkali aqueous solution by the action of an acid, and at least one halogen atom, is 15 to 50 mol % in the total structural units in the resin.

6. The positive resist composition according to claim 1 wherein the alicyclic hydrocarbon skeleton is a skeleton of the following formula (1): 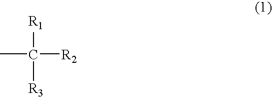
wherein R₂ and R₃ bond to form an alicyclic hydrocarbon ring together with adjacent carbon atom, the alicyclic hydrocarbon ring formed by R₂, R₃ and the carbon atom bonds to at least one group containing a group rendering a resin soluble in an alkali aqueous solution by the action of an acid, and bonds to at least one halogen atom; R₁ represents a hydrogen atom, halogen atom or aliphatic hydrocarbon group.

7. The positive resist composition according to claim 6 wherein the cyclic hydrocarbon skeleton of the formula (1) is an alicyclic hydrocarbon skeleton of the formula (2): 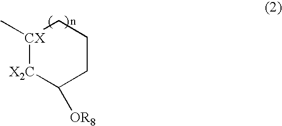
wherein X represents a halogen atom, R₈ represents a hydrogen or an acid-unstable group dissociating in the presence of an acid, and n represents 0 or 1.

8. The positive resist composition according to claim 7 wherein the alicyclic hydrocarbon skeleton of the formula (2) is an alicyclic hydrocarbon skeleton containing a partial structure of the formula (3): 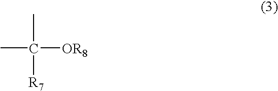
wherein C is a carbon atom forming an alicyclic hydrocarbon skeleton; R₇ represents an alkyl group having 1 to 6 carbon atoms substituted with at least one halogen atom or alicyclic hydrocarbon group substituted with at least one halogen atom; and R₈ has the same meaning as described above.

9. The positive resist composition according to claim 8 wherein the cyclic hydrocarbon skeleton of the formula (2) is an alicyclic hydrocarbon skeleton of the formula (4): 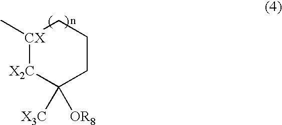
wherein X, R₈ and n have the same meanings as described above.

10. The positive resist composition according to claim 9 wherein R₈ is a group of the formula (5): 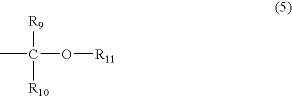
wherein R₉ and R₁₀ each independently represent an alkyl group having 1 to 14 carbon atoms or a hydrogen atom, the alkyl group may have at least one group selected from the group consisting of halogen atoms and alicyclic hydrocarbon groups; R₁₁ represents an alkyl group having 1 to 14 carbon atoms, alicyclic hydrocarbon group, lactone ring group or aromatic hydrocarbon group, the alkyl group may have at least one substituent selected from the group consisting of halogen atom, alicyclic hydrocarbon group and aromatic hydrocarbon group, the alicyclic hydrocarbon group, lactone ring group and aromatic hydrocarbon group in R₁₁ may each independently have at least one substituent selected from the group consisting of halogen atoms and alkyl groups.

11. The positive resist composition according to claim 10 wherein in the formula (5), R₉ and R₁₀ represent a hydrogen atom, and R₁₁ represents an ethyl group.

12. The positive resist composition according to claim 6 wherein the cyclic hydrocarbon skeleton of the formula (1) is a skeleton of the formula (6): 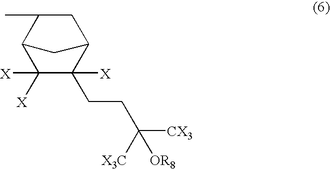
wherein X and R₈ have the same meanings as described above.

13. The positive resist composition according to claim 1 wherein the halogen atom is a fluorine atom.

14. The positive resist composition according to claim 1 wherein the structural unit having an alicyclic hydrocarbon skeleton is a structural unit of the formula (7): 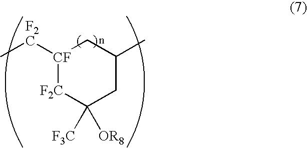
wherein n and R₈ have the same meanings as described above.

15. The positive resist composition according to claim 1 wherein the structural unit having an alicyclic hydrocarbon skeleton is a structural unit of the formula (10): 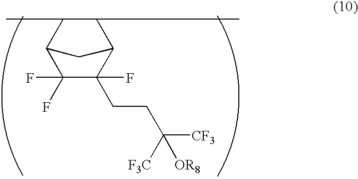
wherein R₈ has the same meaning as described above.

16. The positive resist composition according to claim 1 wherein the resin is a copolymer containing a structural unit of the following formula (8) and a structural unit of the following formula (8-1): 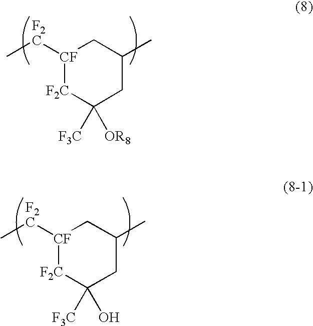
wherein R₈ has the same meaning as described above.

17. The positive resist composition according to claim 1 wherein the resin is a copolymer containing a structural unit of the following formula (9) and a structural unit of the following formula (9-1): 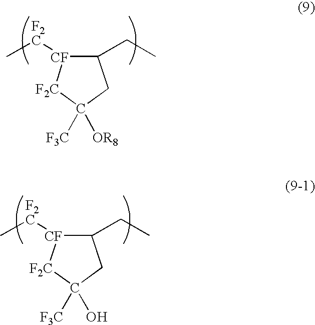
wherein, R₈ has the same meaning as described above.

18. The positive resist composition according to claim 1 wherein the resin is a copolymer containing a structural unit of the following formula (10) and a structural unit of the following formula (10-1): 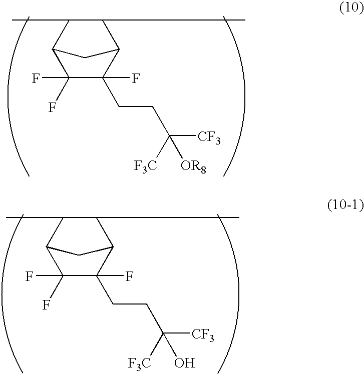
wherein, R₈ has the same meaning as described above.

19. The positive resist composition according to claim 1 wherein the resin is a copolymer containing a structural unit of the following formula (11), a structural unit of the following formula (12) and a structural unit of the following formula (12-1):

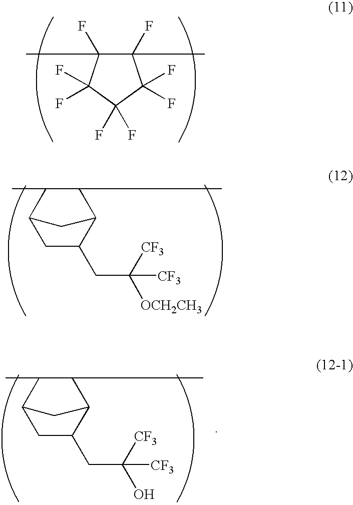

20. The positive resist composition according to claim 1 which further comprises a basic nitrogen-containing organic compound as a quencher.
